(19) United States
(12) Patent Application Publication
(10) Pub. No.: US 2026/0079686 A1
(43) Pub. Date: Mar. 19, 2026

(54) Method and Apparatus for Managing Ad-Hoc User-Centric Interconnectivity of Internet of Things with Apps

(71) Applicant: Qingjun Wei, Montvale, NJ (US)

(72) Inventor: Qingjun Wei, Montvale, NJ (US)

(21) Appl. No.: 19/274,429

(22) Filed: Jul. 18, 2025

Related U.S. Application Data
(63) Continuation-in-part of application No. PCT/US2023/027117, filed on Jul. 7, 2023.
(63) Continuation-in-part of application No. PCT/US2025/010337, filed on Jan. 3, 2025.

(51) Int. Cl. G06F 8/60; H04L 67/51; H04W 4/50; H04W 4/70

(52) U.S. Cl. CPC G06F 8/60; H04L 67/51; H04W 4/50; H04W 4/70

(57) ABSTRACT

An Internet of Things Controller and its new related tools. A Metadata Editor permits a developer of an App to specify metadata that automatically guides each deployment of the App within an end-user's particular network of IoT devices. Once an App is developed, the developer can upload the App to an online App Store, from which the App can be downloaded and deployed by end-users. A Data Editor enables end-users to create their own data, following the developer's metadata, thereby adapting the execution to their specific needs. While permitting adaptation, the Data Editor ensures the data created follows the overall pattern of the metadata, as provided by the developer. Facilities for internationalization of a deployed App's documentation, on a crowd-source basis, are also provided. Apps are “write once, run everywhere” on IoT controllers and devices to achieve optimal security, privacy, safety, power consumption, latency, and bandwidth utilization.

The present US patent application claims benefit of, and priority to, the filing date of the following two PCT patent applications, herein incorporated by reference in their entirety:
“Method and Apparatus for Managing Ad-Hoc User-Centric Interconnectivity of Internet of Things with Apps,” filed 2023 Jul. 7 (y/m/d), having inventor Qingjun Wei and App. No. PCT/US2023/027117.
“Method and Apparatus for Managing Ad-Hoc User-Centric Interconnectivity of Internet of Things with Apps,” filed 2025 Jan. 3 (y/m/d), having inventor Qingjun Wei and App. No. PCT/US2023/010337.

The present US patent application herein incorporates by reference, in its entirety, the following patent application:
US patent application “Managing Ad-Hoc User-Centric Interconnectivity of Internet of Things with Apps,” filed 2022 Jul. 7 (y/m/d), having inventor Qingjun Wei and App. No. 63/367,872.

The present US patent application herein incorporates by reference, in their entirety, the following US patent applications:
US patent application “Application Engine, Application Store, and Graphic Tools for Internet of Things,” filed 2015 Jul. 15 (y/m/d), having inventor Qingjun Wei and App. No. 62/192,667. This can also be referred to as the '667 application.
US patent application “Method and Apparatus for an Internet of Things Controller,” filed 2015 Nov. 9 (y/m/d), having inventor Qingjun Wei and application Ser. No. 14/936,663. This can also be referred to as the '663 application.
PCT Application “Method and Apparatus for an Internet of Things Controller,” filed 2016 Jun. 18 (y/m/d), having inventor Qingjun Wei and Int'l App. No. PCT/US2016/38262. This can also be referred to as the '262 Int'l application.
US patent application “Method and Apparatus for an Internet of Things Controller,” filed 2019 Sep. 30 (y/m/d), having inventor Qingjun Wei and application Ser. No. 16/588,922. This can also be referred to as the '922 application.
US patent application “Method and Apparatus for an Internet of Things Controller,” filed 2021 Dec. 28 (y/m/d), having inventor Qingjun Wei and application Ser. No. 17/563,978.
US patent application “Method and Apparatus for an Internet of Things Controller,” filed 2023 Aug. 14 (y/m/d), having inventor Qingjun Wei and application Ser. No. 18/233,849.

### TECHNICAL FIELD

The present invention relates generally to the Internet of Things (or “IoT”), and, more particularly, to interaction and interconnection between IoT devices.

### BACKGROUND ART

Permitting an end-user to increase his or her ability to interact with IoT devices can be referred to herein as the “interaction problem.” Permitting greater interconnection, between an end-user's IoT devices, can be referred to herein as the “interconnection problem.”

Patentee's prior patent applications, focused on the interaction problem, are listed above and include the '667 application, the '663 application, the '922 application, and the '262 Int'l application.

The '663 application, '922 application, and '262 Int'l Application can be referred to herein as the “Prior Applications.”

In the Prior Applications, patentee invented a new type of IoT controller, that permits the App developer to grant the end-user greatly enhanced interaction with the IoT devices coupled to such controller. The goal is a naturally optimal design of IoT applications. The developer writes any IoT control algorithm as a function in a standard programming language, such as TypeScript or Rust. That function can be shared as an IoT application with billions of users with an optimal, intuitive, and familiar user interface (UI) that can be automatically generated by analyzing the source code. At the same time, the developer can further manually optimize the UI. Patentee's approach can scale to the large number of devices and end-users (e.g., billions) envisioned for IoT.

However, in addition to interaction, IoT originally envisioned greatly enhanced interconnection among “things,” once they are IoT devices. Unfortunately, large Information Technology (“large IT”) companies have emphasized cloud computing, as the interconnecting medium between IoT devices.

Patentee's Prior Applications have greatly improved cloud-centric approaches. For example, by introducing an IoT controller (or hub) that can, at a deployment location, operate independently of a cloud, and in close physical proximity to the IoT devices it controls. The advantages of more local and distributed control include the following:
Lower latency, between sensing a change and acting in response.
Continued operation of IoT apps despite a greatly degraded (or lost) Internet connection with the cloud.
Continued operation of IoT apps despite a loss of operation by the cloud.
Opportunities for enhanced end-user privacy.

Accordingly, there are additional benefits to be gained, by further distributed and localized control.

### BRIEF SUMMARY OF THE INVENTION

For the methods of the present invention, each step can be performed at least in part with a configuration of computing hardware and programmable memory.

The invention relates to a first method for automatically deploying and running any number of independent instances of an application within an IoT network. The steps of the first method can comprise the following.

Receiving an application created by a developer.

Receiving the application meta data, as created by a developer, for the automatic deployment of the application.

Receiving the application including, in the meta data, a deployment policy.

Using the meta data to automatically generate a GUI by which an end-user builds a data tree configured for a specific IoT network.

Presenting, to an IoT controller, the application and the data tree.

Traversing the data tree, find the minimum partition for each qualified physical device.

Using the found minimum partitions, the IoT controller does steps comprising the following for each qualified physical device:
loading an instance of the application;
giving the application instance that minimum partition containing the peer logical devices to which it needs to connect; and
connecting the application instance to its peer logical devices.

The invention can also relate to a second method, comprised of the first method and the following step:

automatically finding for each qualified physical device the minimum partition needed to run the application instance on the qualified physical device.

The invention can also relate to a third method, comprised of the second method and the following step:

deploying, based on deployment attributes, an application instance to all qualified physical devices, just to any single qualified physical device or to no qualified physical device.

The invention can also relate to a fourth method, comprised of the third method and the following steps:
having a physical device with a CPU and a local logical device;
having a field for each logical device, through the application meta data, called Deployment Policy;
skipping deployment of an instance of the application, if the Deployment Policy is not set, including skipping the deployment of an instance of the application on the physical device that hosts the logical device;
determining on which physical devices the application will run, wherein Deployment Policy choices include ALL or ANY and the determining steps comprise:
   finding, for a first set of logical devices having a Deployment Policy of ALL, a first set of qualified physical devices that can each host the first set of logical devices, and deploying the application on each member of the first set of qualified physical devices;
   finding, for a second set of logical devices having a Deployment Policy of ANY, a second set of qualified physical devices that can each host the second set of logical devices, and deploying the application on only one member of the second set of qualified physical devices.

The invention can also relate to a fifth method, comprised of fourth method and the following step:

traversing the data tree to produce the minimum partition necessary to deploy application instances on the qualified physical devices.

The invention can also relate to a sixth method, comprised of the fifth method and the following step:
connecting the application instance on the qualified physical device to its peer logical devices.

The invention can also relate to a seventh method, comprised of the third method and the following step:
deploying, when a deployment attribute for removal of dependencies is present, an application instance with a partition where specified absolute and relative paths of the data tree have been trimmed off.

The invention can also relate to an eighth method, comprised of the seventh method and the following step:
traversing the data tree to produce the minimum partition necessary to deploy application instances on the qualified physical devices while ignoring the explicitly specified paths.

The invention can also relate to a ninth method, comprised of the eighth method and the following step:
connecting the application instance on the qualified physical device to its peer logical devices.

The invention can also comprise a tenth method, comprised of the first method and the following step:
using a portion of the data tree as a minimum partition.

The invention can also comprise an eleventh method, comprised of the first method and the following step:
using the entire data tree as a minimum partition.

The invention can also comprise a twelfth method, comprised of the eleventh method and the following step:
using the entire data tree as a minimum partition if the meta data does not contain a partitioning attribute.

The invention can comprise a thirteenth method for automatically deploying and running any number of independent instances of an application within an IoT network, comprising:
receiving, performed at least in part with a configuration of computing hardware and programmable memory, an application created by a developer;
receiving, performed at least in part with a configuration of computing hardware and programmable memory, the application meta data, as created by a developer, for the automatic deployment of the application;
receiving, performed at least in part with a configuration of computing hardware and programmable memory, the application including, in the meta data, a deployment policy;
using, performed at least in part with a configuration of computing hardware and programmable memory, the meta data to automatically generate a GUI by which an end-user builds a data tree configured for a specific IoT network;
presenting, to an IoT controller, performed at least in part with a configuration of computing hardware and programmable memory, the application and the data tree;
traversing the data tree, performed at least in part with a configuration of computing hardware and programmable memory, find the minimum partition for each qualified physical device;
using the found minimum partitions, the IoT controller does steps, performed at least in part with a configuration of computing hardware and programmable memory, comprising the following for each qualified physical device:
   loading, performed at least in part with a configuration of computing hardware and programmable memory, an instance of the application;
   giving, performed at least in part with a configuration of computing hardware and programmable memory, the application instance that minimum partition containing the peer logical devices to which it needs to connect; and
   connecting, performed at least in part with a configuration of computing hardware and programmable memory, the application instance to its peer logical devices.

The invention can also relate to a first data processing system, made with computing hardware and programmable memory, for automatically deploying and running any number of independent instances of an application within an IoT network. The sub-systems, of the first data processing system, can comprise the following:
a sub-system configured, at least in part with computing hardware and programmable memory, to accomplish receiving an application created by a developer;
a sub-system configured, at least in part with computing hardware and programmable memory, to accomplish receiving the application meta data, as created by a developer, for the automatic deployment of the application;
a sub-system configured, at least in part with computing hardware and programmable memory, to accomplish receiving the application including, in the meta data, a deployment policy;
a sub-system configured, at least in part with computing hardware and programmable memory, to accomplish using the meta data to automatically generate a GUI by which an end-user builds a data tree configured for a specific IoT network;
a sub-system configured, at least in part with computing hardware and programmable memory, to accomplish presenting, to an IoT controller, the application and the data tree;
a sub-system configured, at least in part with computing hardware and programmable memory, to accomplish the following: traversing the data tree, find the minimum partition for each qualified physical device;
a sub-system configured, at least in part with computing hardware and programmable memory, to accomplish the following: using the found minimum partitions, the IoT controller does steps comprising the following for each qualified physical device:
   loading an instance of the application;
   giving the application instance that minimum partition containing the peer logical devices to which it needs to connect; and
   connecting the application instance to its peer logical devices.

The invention can also relate to a second data processing system, for automatically deploying and running any number of independent instances of an application within an IoT network, comprising:
one or more processors and programmable memory, wherein the system is configured:
to accomplish receiving an application created by a developer;
to accomplish receiving the application meta data, as created by a developer, for the automatic deployment of the application;
to accomplish receiving the application including, in the meta data, a deployment policy;
to accomplish using the meta data to automatically generate a GUI by which an end-user builds a data tree configured for a specific IoT network;
to accomplish presenting, to an IoT controller, the application and the data tree;
to accomplish traversing the data tree, and finding the minimum partition for each qualified physical device;
to accomplish using the found minimum partitions, and the IoT controller does steps comprising the following for each qualified physical device:
   loading an instance of the application;
   giving the application instance that minimum partition containing the peer logical devices to which it needs to connect; and
   connecting the application instance to its peer logical devices.

### BRIEF DESCRIPTION OF THE DRAWINGS

The accompanying drawings, that are incorporated in and constitute a part of this specification, illustrate several embodiments of the invention and, together with the description, serve to explain the principles of the invention:

FIG. 1 depicts how a Thing-App works from an end-user's point of view.

FIG. 2A presents an example of simple bindings among IoT devices.

FIGS. 2B and 2C present an example of Matter's implementation of interconnection handling.

FIG. 3 depicts the language binding for programming languages such as TypeScript and Rust.

FIGS. 4A and 4B present the pseudocode of the user input data partition algorithm for massive Thing-App task deployment.

FIG. 4C presents the pseudocode of the automatic interconnection configuration algorithm for Thing-App task deployment on an IoT device.

FIG. 4D presents: On the left side, part of the example source code of the actuators' controller Thing-App declares the input data structure and App function signature with parameters. On the right side, the developer added metadata attributes on each metadata node corresponding to the source code on the left.

FIG. 4E presents the attribute of each meta-data node of the example source code as the screenshots of the Libertas Schema Editor.

FIG. 4F presents the attributes for deploying Thing-App to run on IoT devices.

FIG. 4G presents the list of parts of the example Thing-App deployment.

FIG. 4H1 presents an example of end-user input data for a task of the actuators' control example, with the list of parts in FIG. 4G.

FIG. 4H2 presents the relationship between the user tree node and the data structure tree node in the developer's source code, which corresponds to the tree node of the metadata (schema) tree.

FIG. 4J-4W presents the transition of an example UI implementation for an end user to input the data in FIG. 4H.

FIG. 4X presents the user data partition based on the example list of parts in FIG. 4G and the example user data in FIG. 4H.

FIGS. 5A-5C present the raw metadata of the example in JSON format.

FIG. 6 depicts how a Thing-App works from an end-user's point of view.

FIG. 7 presents an example of simple bindings among IoT devices.

FIG. 8 presents (on the left side) part of the source code (800) that declares the input data structure of a Thing-App of a “smart” sprinkler scheduler, and (on the right) an instance (810) of a corresponding automatically generated UI on an end-user's smartphone.

FIG. 9A presents part of the example source code of the actuators' controller Thing-App, that declares the input data structure and App function signature with parameters.

FIG. 9B presents the attribute of each meta-data node of the example source code, as the screenshots of the Libertas Schema Editor.

FIG. 9C presents a screenshot of client input data on an end-user's smartphone, with the “trimmed” end-user data for each deployed device (actuator).

FIGS. 10A-10C present the raw metadata of the example in JSON format.

### MODE(S) FOR CARRYING OUT THE INVENTION

Reference will now be made in detail to various embodiments of the invention, examples of which are illustrated in the accompanying drawings. Wherever possible, the same reference numbers will be used throughout the drawings to refer to the same or like parts.

Application software may be referred to more simply herein as “applications,” or, with even more brevity, “Apps.”

Please refer to the section titled “Glossary of Selected Terms,” for the definition of selected terms used below.

Table of Contents to Detailed Description

| Contents | |
|---|---|
| TECHNICAL FIELD | 2 |
| BACKGROUND ART | 2 |
| BRIEF SUMMARY OF THE INVENTION | 3 |
| BRIEF DESCRIPTION OF THE DRAWINGS | 8 |
| MODE(S) FOR CARRYING OUT THE INVENTION | 9 |
| 1 Introduction | 14 |
| 2 Thing-App | 15 |
| 2.1 User input data and Thing-App task | 17 |
| 2.2 Thing-App developer and end-user | 17 |
| 2.3 Language binding | 18 |
| 2.4 Meta-data and node attributes | 19 |
| 2.5 Libertas OS, Libertas SDK and Thing-App engine | 19 |
| 3 Physical devices and endpoints (logical devices) | 20 |
| 3.1 Endpoint and the standard data model | 20 |
| 3.2 LibertasDevice is endpoint | 21 |
| 3.3 Run Thing-Apps on physical devices to control endpoints locally | 22 |
| 4 Why does interconnectivity matter? | 22 |
| 5 Central controller, hub, and gateway | 23 |
| 6 Interconnection (Binding) | 24 |
| 6.1 Simple and App binding | 26 |
| 6.1.1 Local App Endpoint | 27 |
| 6.1.2 Assignment of App Endpoints | 27 |
| 6.1.3 App Endpoint Pool | 27 |
| 6.1.4 Thing-App Endpoint Management | 28 |
| 6.1.5 Thing-App Endpoint to Peer Mapping | 28 |
| 6.2 Internal interconnection and Thing-App internal binding | 28 |
| 6.3 Read/write device access attributes and protocol access control list | 29 |
| 6.4 Unicast vs. Multicast | 30 |
| 6.5 Proxy | 31 |
| 6.6 Hub Thing-App deployment vs. device Thing-App deployment | 31 |
| 6.7 Translating Thing-App interconnections into protocol-specific interconnection | |
| configurations | 31 |
| 6.7.1 Interconnections with peers running the same protocol | 32 |
| 6.7.2 Interconnections with peers running different protocols | 33 |
| 7 Security | 33 |
| 8 Network Configuration | 34 |
| 9 Non-volatile Memory | 34 |
| 10 Deployment target meta-data attribute | 35 |
| 10.1 Qualified devices | 35 |
| 10.2 DeploymentPolicy attribute | 35 |
| 11 Massive deployment (DeploymentPolicy == ALL) | 36 |
| 11.1 Input data partitioning for massive deployment | 36 |
| 11.2 AutoPartition Attribute | 37 |
| 11.3 DeployRemoveDependencies | 38 |
| 11.4 “AutoPartition” and “DeployRemoveDependencies” | 38 |
| 11.5 Selecting Physical Devices as Deployment Targets | 39 |
| 11.6 Hub Split Deployment | 39 |
| 11.7 Pseudocode of the algorithms | 40 |
| 11.7.1 User input data partitioning | 40 |
| 11.7.2 Automatic interconnection setup | 40 |
| 11.8 Practical Limitations | 40 |
| 12 An Example | 41 |
| 12.1 The code and metadata | 41 |
| 12.2 The example hardware parts list | 43 |
| 12.2.1 Actuator controller | 43 |
| 12.2.2 Sensors | 43 |
| 12.3 Running code on each actuator controller device | 43 |
| 12.4 Example user input data | 44 |
| 12.5 The user interface | 44 |
| 12.6 The partitioned user data | 45 |
| 12.7 Simulation of the data partition algorithm | 46 |
| 12.7.1 Simulation with “AutoPartition” alone | 46 |
| 12.7.2 Simulation with “DeployRemoveDependencies” | 48 |
| 12.8 Robustness of data partition algorithm | 49 |
| 12.9 Simulation of automatic interconnection algorithm | 49 |
| 12.10 Additional Example Data | 50 |
| 13 Every IoT application can be a Thing-App | 50 |
| 14 Additional Information | 50 |
| 14.1 IoT Device | 50 |
| 14.2 Computing Equipment | 53 |
| 14.3 High-level data partition algorithms | 54 |
| 14.3.1 Prerequisites | 54 |
| 14.3.2 Auto partition algorithm | 55 |
| 14.3.3 “DeploymentRemoveDepedency” partition algorithm | 56 |
| 14.4 High-level interconnection configuration algorithm | 57 |
| Gossary of Selected Terms | 57 |
| 15 Appendix | 60 |
| 15.1 Introduction | 60 |
| 15.2 Thing App | 61 |
| 15.3 Why does interconnectivity matter? | 63 |
| 15.4 Node and endpoints | 64 |
| 15.4.1 Load and non-load endpoints | 64 |
| 15.4.2 LibertasDevice | 64 |
| 15.5 Binding | 65 |
| 15.5.1 Simple and App binding | 66 |
| 15.5.2 Internal Binding | 67 |
| 15.5.3 Read/write device access and binding direction | 67 |
| 15.5.4 Unicast vs. Multicast | 67 |
| 15.5.5 Proxy | 68 |
| 15.6 Central controller, hub, and gateway | 68 |
| 15.7 Data security | 69 |
| 15.8 Network Configuration | 69 |
| 15.9 Non-volatile Memory | 70 |
| 15.10 Thing-App developer and end-user | 70 |
| 15.11 Meta-data and node attributes | 71 |
| 15.12 Deployment target | 71 |
| 15.12.1 Qualified node | 72 |
| 15.12.2 DeploymentPolicy attribute | 72 |
| 15.13 Binding from App deployment to devices | 73 |
| 15.14 Massive deployment | 73 |
| 15.14.1 Binding for massive deployment | 74 |
| 15.14.2 DeployRemoveDependencies | 74 |
| 15.14.3 Hub Split Deployment | 75 |
| 15.15 An Example | 75 |
| 15.15.1 The code | 76 |
| 15.15.2 The user input data | 76 |
| 15.16 App Binding | 77 |
| 15.17 Further Optimization | 77 |
| 15.18 Additional Information | 77 |
| 15.18.1 IoT Device | 77 |
| 15.18.2 Computing Equipment | 80 |
| 15.19 Glossary of Selected Terms | 81 |

### 1 Introduction

As mentioned above, patentee has Prior Applications which focus on an Internet of Things (IoT) central controller, and related tools. The tools address application development and deployment. First, a Meta-Data Editor permits a developer to specify meta-data. See either of the Prior Applications, Section 5 (“Meta-Data Editing or Extraction”). The meta-data then guides the structure of actual data entered by the end user. See either of the Prior Applications, Section 6 (“Argument Editor”).

Once an application is developed and has undergone a test deployment, the developer can upload the application to an online “IoT Application Store,” from which the application can be downloaded and deployed by others. See either of the Prior Applications, Section 2 (“An IoT App Store”) and Section 3 (“An IoT Ecosystem”). As mentioned above, an Argument Editor (or “Data Editor”) permits an end-user to create his or her own data, in accordance with the developer's meta-data, that adapts the execution to his or her particular needs.

For the present invention (also referred to herein as the “Libertas system” or simply “Libertas”), the meta-data has been augmented with new attributes. Such new attributes can be passed to the application when invoked as a particular execution (or process or task) for a particular end-user.

The developer may designate a meta-data node with the type of an IoT logical device as the App's deployment target. Such designations become active once a new deployment request is received from an end-user with his or her end-user-created data. In response, the central controller can perform the following steps:
Automatically select a set of IoT devices and sensors as “qualified” deployment targets from all related IoT devices. (See below for definition of “Qualified node.”)
Automatically restructure the interconnection among related IoT device nodes during the deployment process.
Deploy the Thing-App code and configuration data to one or more “deployment target” devices and run Thing-App task inside those devices. The running Thing-App will directly interact with all IoT devices related to the particular task(s).

### 2 Thing-App

As mentioned above, the Prior Applications include an IoT App Store and Ecosystem.

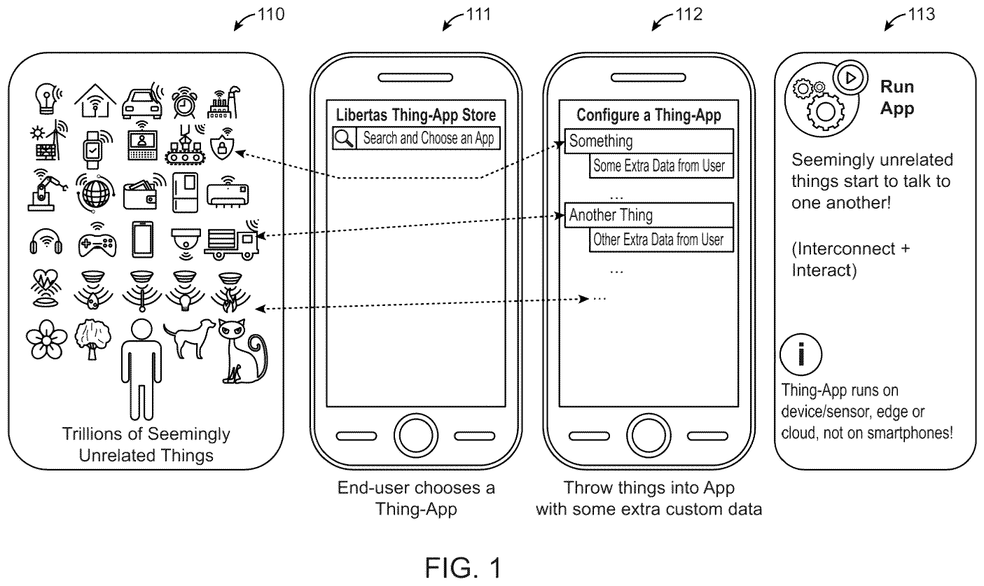

For purposes of the present patent, a term called “Thing-App” is introduced, which is augmented with interconnection meta-data. At a high-level, a Thing-App can be viewed, in conjunction with FIG. 1, as working as follows:
1. Viewed most broadly, outline 110 of FIG. 1 represents the eventual possibility of trillions of IoT “things” (or devices) deployed worldwide. In their initial state, such IoT things can default to having no interconnectivity with each other. Only a small subset of IoT devices is available to any particular end-user, which we can refer to as the end-user's Device Set.
2. As discussed above, the Prior Applications include an IoT App Store (or what may also be called a Thing-App Store). An example interface, by which an end-user can select a Thing-App from the Thing-App store, is depicted as available to an end-user through a Smartphone interface 111 (see FIG. 1).
   An end-user can use the interface to choose a Thing-App for deployment on his or her Device Set.
3. Once a Thing-App is selected, Smartphone interface 112 represents an end-user accomplishing at least two types of configuration:
   a. From the end-user's Device Set, choosing the particular IoT things for execution of the chosen Thing-App (the chosen IoT Things). Such selection can be referred to as “throwing” the selected things into the chosen Thing-App.
   b. Using the Data Editor to configure (in accordance with the developer's meta-data) the behavior of the selected things under the chosen Thing-App. Such end-user configuration data is referred to as “Extra Data from User” in Smartphone interface 112. In general, this can be referred to as an App configuration process.
4. Smartphone interface 113 represents the end-user starting the Thing-App to run. Unknown to the end-user, and in accordance with deployment meta-data from the developer, execution of the chosen Thing-App is deployed to the chosen IoT Things. Prior to the deployment invention, each IoT device, of the end-user's Device Set, may have been unrelated to each other IoT device of the Device Set. At most, their interconnection would be through the IoT controller or hub (as described in the Prior Applications). However, with the present invention, these seemingly unrelated IoT things (or devices) begin to communicate with each other—without such messaging needing to pass through the IoT hub. The chosen IoT Things represent their own autonomous network (or set of interconnections) that has advantages, relative to the hub, similar to those of the hub relative to the cloud:
   a. Lower latency, between sensing a condition and acting in response.
   b. Continued operation of IoT apps despite a greatly degraded (or lost) network connection with the hub.
   c. Continued operation of IoT apps despite a loss of operation by the hub.
   d. Opportunities for enhanced end-user privacy.

The implementation requires the end-user to input data (called a data instance) with a tree structure. The application developer defines the tree data's structure (by creating a schema or metadata).

Mostly, the Thing-App is not running on Smartphones. Rather, as discussed above, it can run on the relatively tiny computer system provided to IoT devices. More specifically, the on-board computer system typically provided to an IoT device is called a Micro-Controller Unit (MCU). More generally, the deployment procedure, executed by an IoT hub, will automatically pick the best node to run the Thing-App. (While it may be an IoT device, depending on the circumstances, it may also be the hub, or an edge or cloud server may be selected.) The net result for the developer is an ability to “write once, run everywhere” on any of the billions of MCU chips resident within billions of IoT devices.

The decentralized approach of the present invention means an IoT that centers much more around the end-user, instead of where the end-user's apps are executed. No other solution is known to offer applications running on essentially any node (or IoT device) within a distributed IoT network. Solutions prior to the Prior Applications rely on a “centralized” location for interconnection and interaction, such as a cloud or an edge device.

Even running Thing-Apps within an IoT device without interacting with other external devices gives end-users unprecedented flexibility. Even for everyday electronic devices such as Thermostats and Sprinkler controllers, different end-users will prefer different “smart” algorithms to control their devices. As a result, end-users are empowered with the freedom to choose Thing-Apps for their IoT devices, and developers will have a chance to freely write Thing-Apps to freely interact with possibly anything and share the Thing-Apps with billions of end-users.

Once Thing-Apps become “write once, run everywhere,” there is always a good reason to treat every IoT device as a general-purpose computer with a few standard peripherals and leave everything else to Thing-App developers. Essentially, device firmware becomes Thing-Apps.

Further, the present invention offers an “ad-hoc” and user-centric approach to IoT network design. Guided by the developer's meta-data, the invention can dynamically restructure and optimize interaction among nodes within an IoT network when an end-user deploys a new App instance or removes an existing App instance. By optimizing interaction, new interconnections among related “things” may be automatically established.

There are many advantages to an “ad-hoc” user-centric approach, including greater security, greater privacy, better reliability, lower latency, longer battery life, and more efficient network bandwidth utilization.

### 2.1 User Input Data and Thing-App Task

End-users are not programmers. In our design, the end-user is only required to use our GUI tool to create instances of Thing-App tasks. After all, a task is a running process comprised of the executable code (Thing-App code) and data. The user input data is tree data following the developer's metadata (schema) (directly extracted from the data structure definition from the Thing-App source code). This design brings optimal experience to developers and users.

The user input data is also referred to as “configuration.” Throughout this document, the terms “user input data,” “user data,” and “configuration” are interchangeable.

### 2.2 Thing-App Developer and End-User

Thing-App developers write App code and share the App with end-users.

A Thing-App function is a function in standard programming languages such as TypeScript or Rust. It usually has arguments. A Thing-App function is an “entry” function of a Thing-App process (task), like the “main” function in C and Java languages. It is just more flexible than the “main function.” First, it can be of any name. Secondly, it takes a list of well-defined tree structures instead of a list of strings.

An end-user causes the execution of an App by creating an App process, instance, or task. While creating an App instance, the end-user creates an instance of the input arguments for the function, also called startup configuration or simply configuration.

The arguments of a Thing-App function can be any data structure defined by the Thing-App developer, which is usually a tree data structure. The App developer declares the tree structures in the source code (or with our GUI tool for untyped languages such as JavaScript or Lua). The declaration of the data structures is also a tree structure referred to above as meta-data or schema.

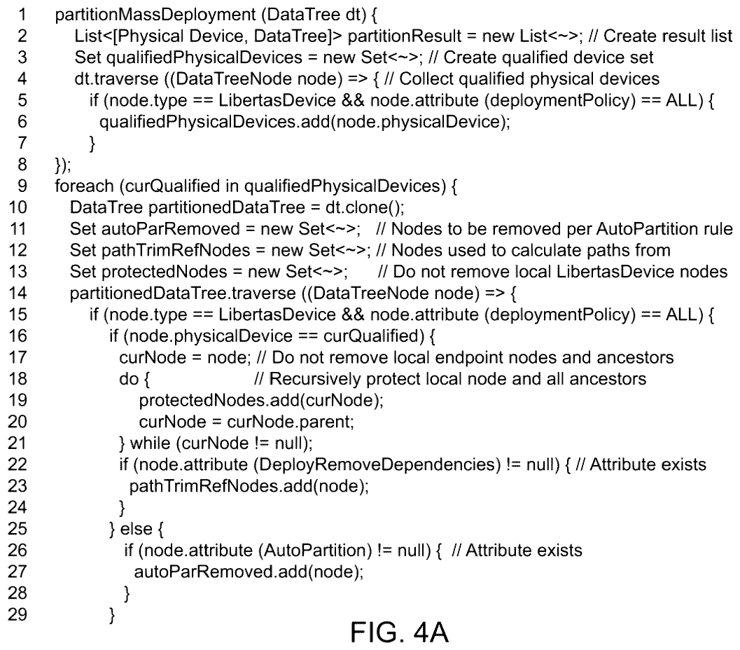

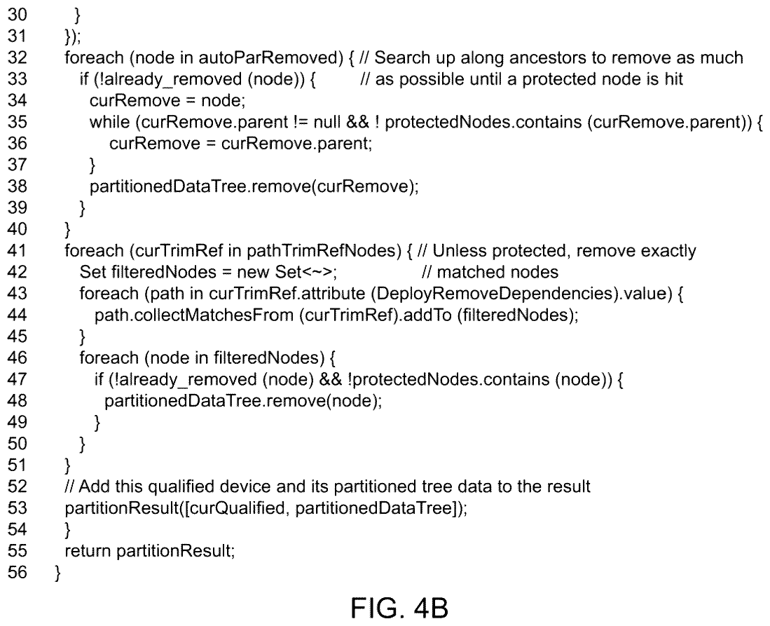

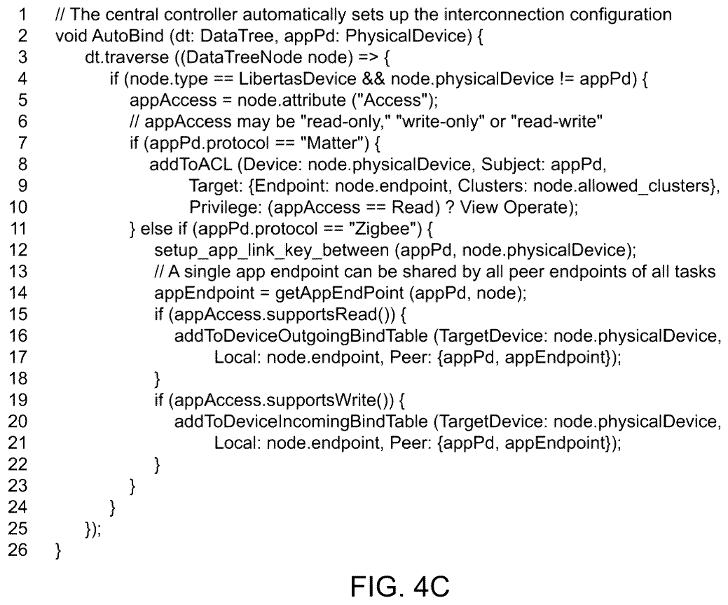

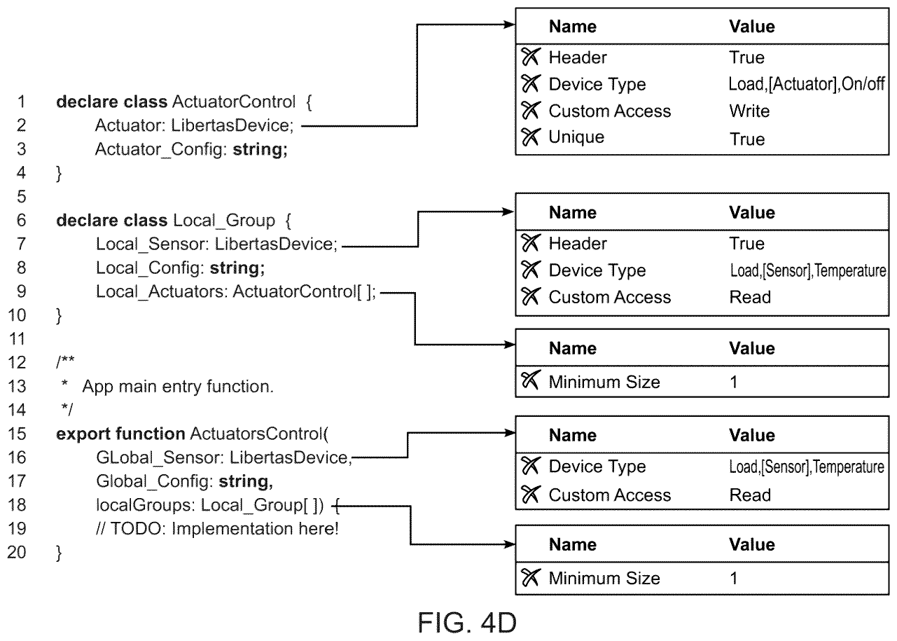

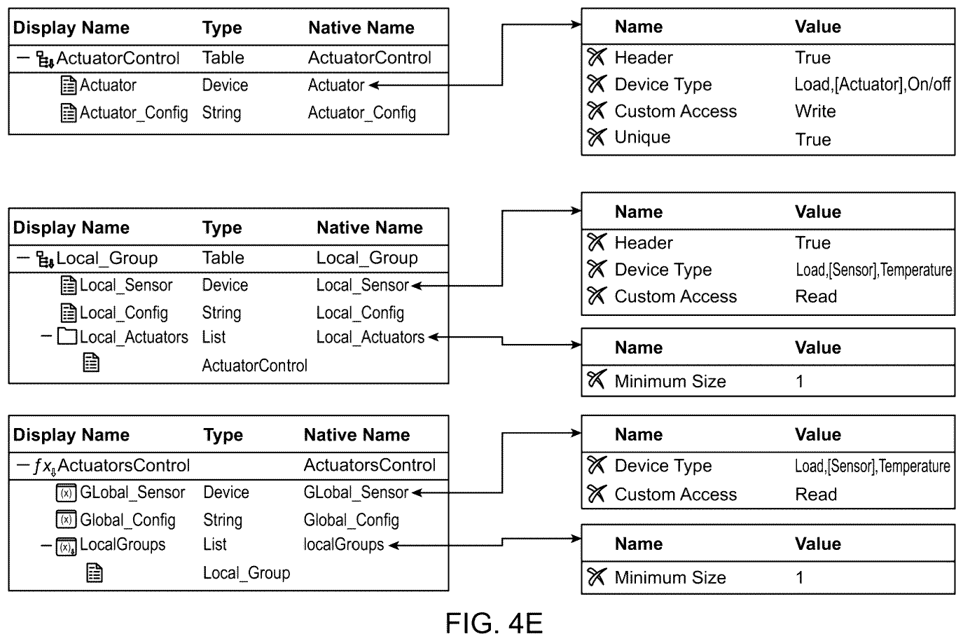

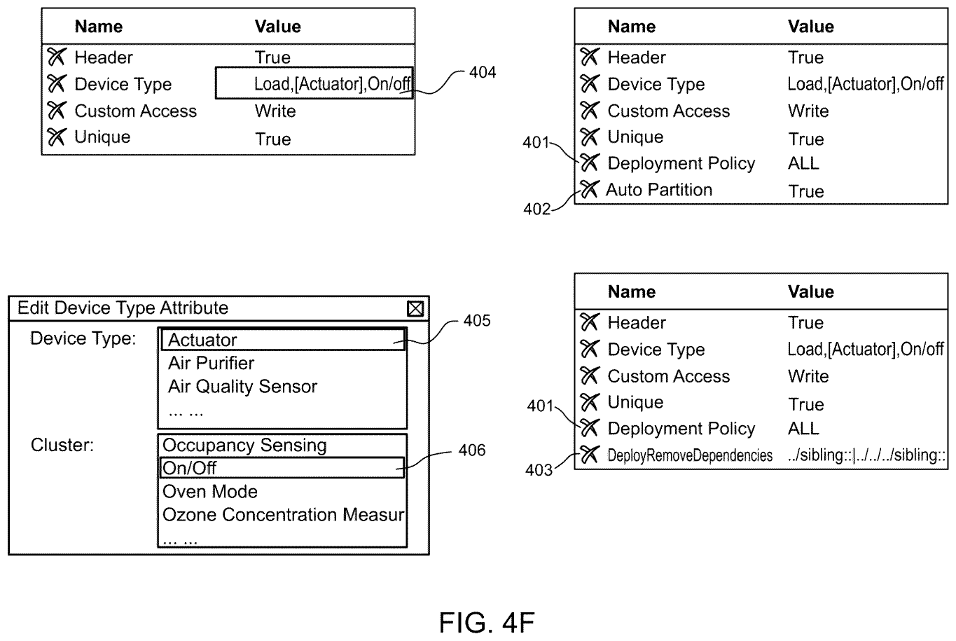

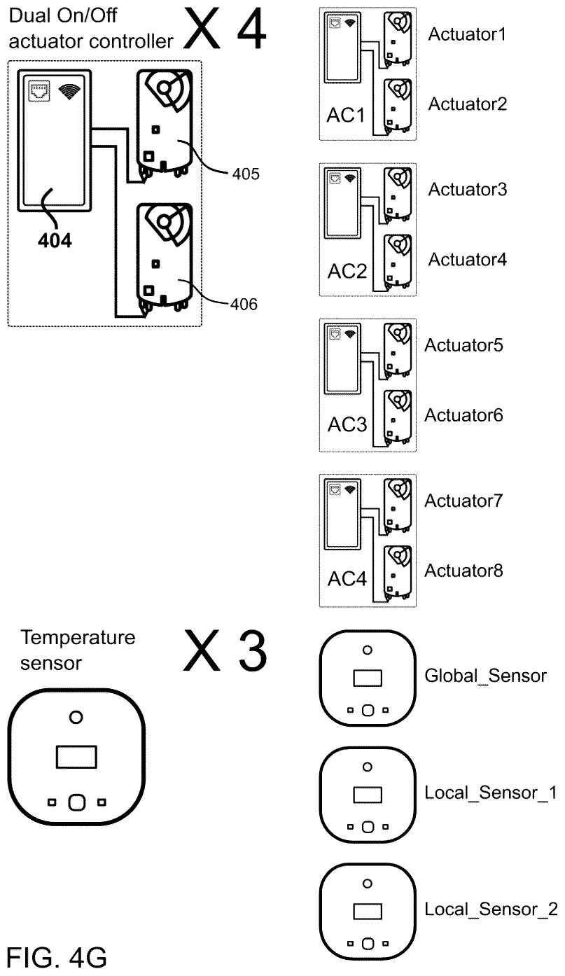

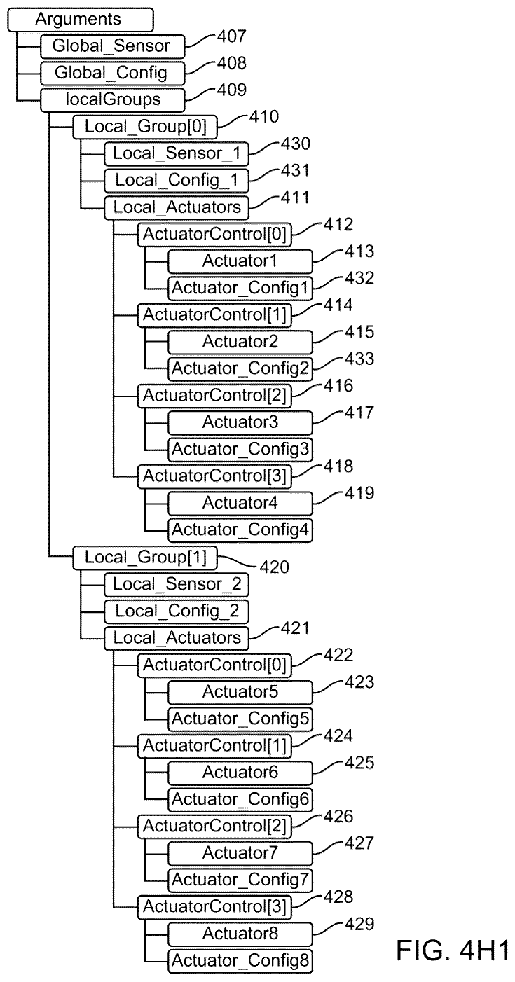

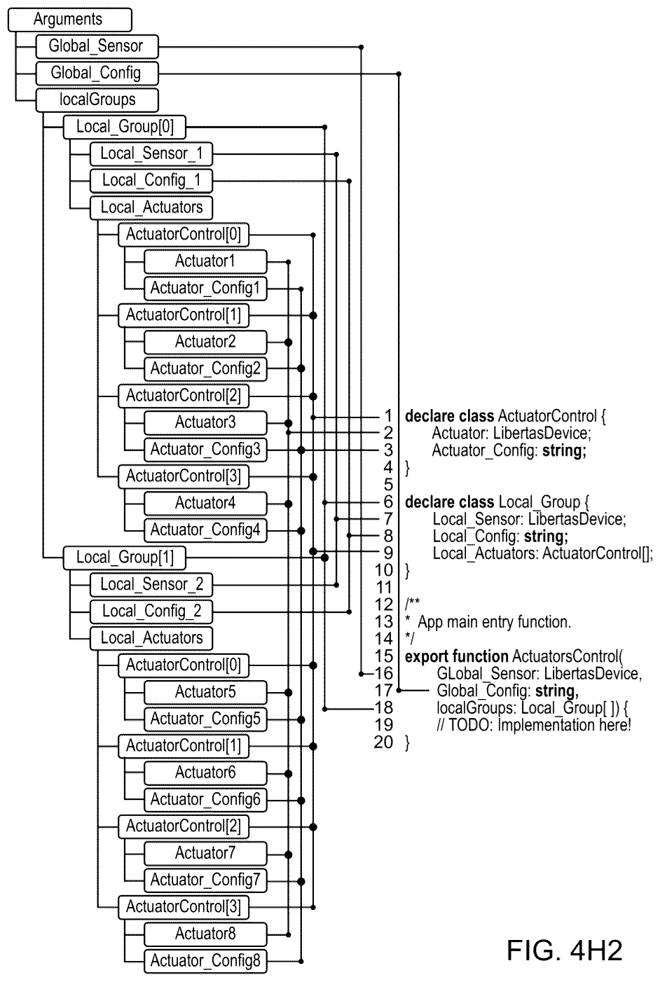

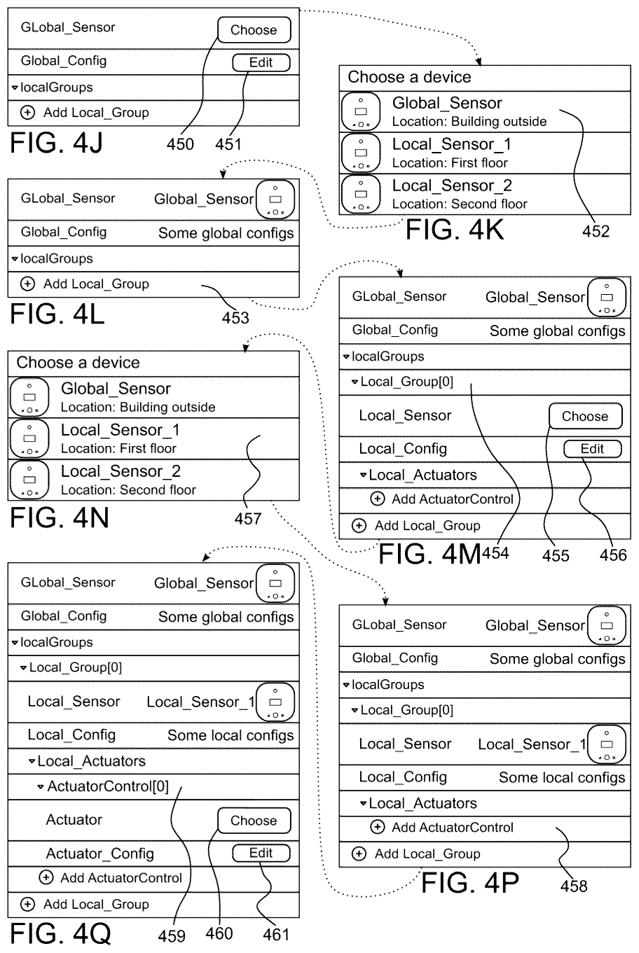

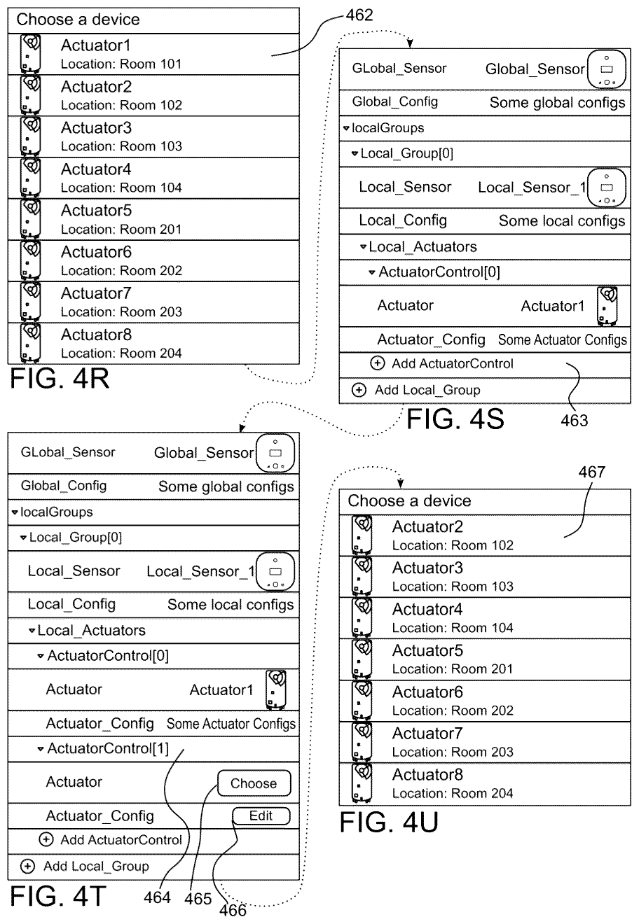

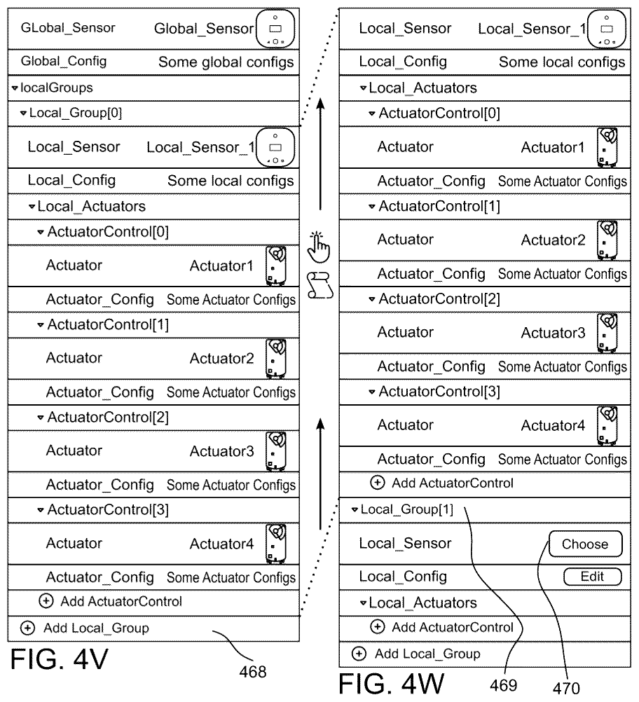

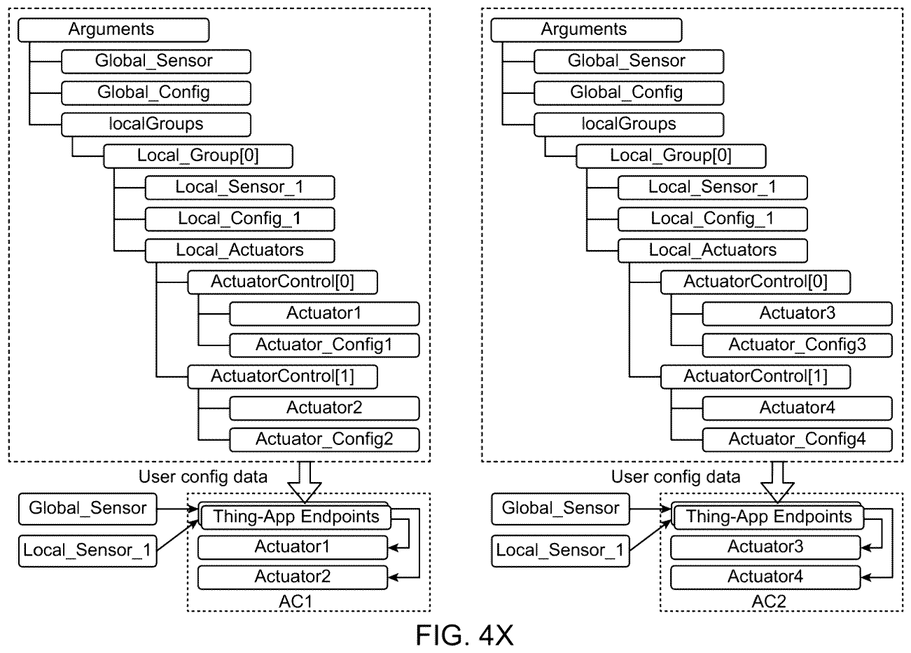

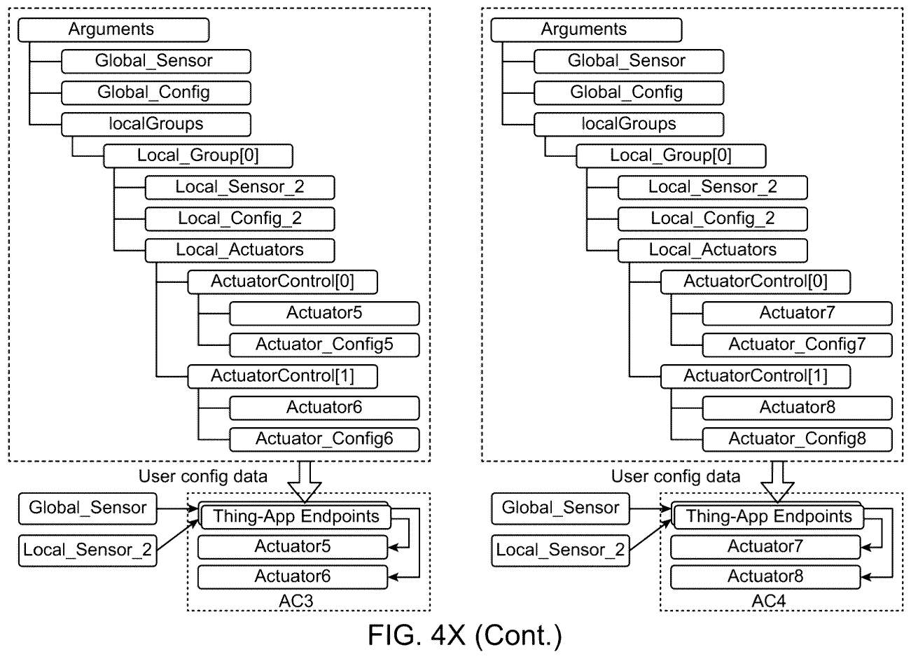

FIG. 4H2 depicts how the developer's declaration in the source code (TypeScript) precisely defines the metadata of the user input data. On the left side is an example instance of a user data tree, and on the right is the data structure declaration of the corresponding source code. Connections between the user data node and the metadata node (on source code) are also drawn. It is important to remember that:
1. Each data node must have one corresponding meta-data node.
2. By definition, each item of an array shares the same meta-data node.
3. The same class member shares the same meta-data node even on different class instances.

The metadata is used to generate the user interface (UI) automatically. FIG. 4J-4W demonstrates how the user uses the UI to input the instance of the example data tree.

### 2.3 Language Binding

Thing-App Developers write Thing-App functions in standard programming languages. We provide development tools as an IDE (Integrated Development Environment), including a custom code editor, a custom compiler, additional GUI tools, and a unified Thing-App API.

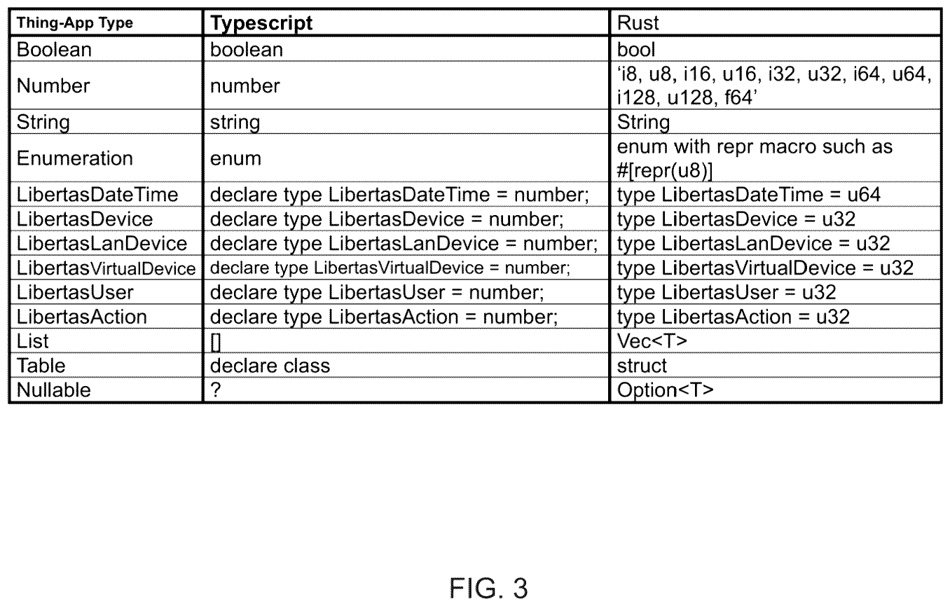

The metadata for the user input config data is a tree structure, with every node having a concrete type. FIG. 3 lists an example language binding for two programming languages: TypeScript and Rust.

These languages offer inherent safety guarantees crucial for the App ecosystem. Rust also offers performance equivalent to that of C language.

Some data types in the language binding are “Opaque types.” Libertas defines those types as alias types, and the values of those types are only “passed through” among Libertas API. For example, the “LibertasDevice” type is defined as a number type. It represents an internal ID of a logical IoT device. The end-user provides the actual value of the logical device as part of the input data during the configuration process. The input data is then passed as the arguments of the function. The Thing-App code can use the value of the LibertasDevice to communicate with the logical IoT device through API. The value only serves as an “access token” instead of an actual number.

Furthermore, the actual type of those “opaque types” can be very flexible. For example, the type of “LibertasDevice” can later be redefined as a string or struct type. The developer's source code that refers to those opaque types doesn't need to change.

FIG. 3 table defines several opaque types: LibertasDevice, LibertasLanDevice, LibertasVirtualDevice, LibertasUser, and LibertasAction.

### 2.4 Meta-Data and Node Attributes

A developer may add various attributes to a meta-data (or schema) node. An attribute may relate to a feature in the front-end UI, a back-end transaction, or both.

Depending on the nature of the programming language used to develop the Thing-App, the node attributes can be specified in the source code as design-time attributes or through a GUI-based meta-data editor. For an example of a meta-data editor, see Prior Applications, Section 5 (“Meta-Data Editing or Extraction”). FIGS. 4D and 4E depict using meta-data editor GUI to manage additional attributes of meta-data nodes.

Note: official TypeScript does not support design-time attributes. Patentee's meta-data editor is a more robust solution for many programming languages.

### 2.5 Libertas OS, Libertas SDK and Thing-App Engine

Libertas OS is an IoT Operating System that enables a device to run Thing-App tasks locally. Like Android runs on top of Linux and iOS runs on top of FreeBSD, Libertas OS runs on top of other common Operating Systems, such as Linux or various real-time Operating Systems for Microcontrollers (MCUs). Like Android or iOS, Libertas OS offers software components called the Thing-App engine to manage and execute Thing-App tasks running on the device.

Libertas SDK is the software development kit for system developers to develop device firmware with Thing-App capability.

### 3 Physical Devices and Endpoints (Logical Devices)

A physical IoT device in an IoT network is usually called a “node” in IoT standards such as Zigbee and Thread. A node should have a unique ID across an IoT network. This invention involves tree data structures with tree nodes. To avoid confusion, we often use the term “physical device.” We may use the term “an IoT network node” for an IoT physical device in an IoT network because it won't confuse.

In FIG. 4G, we defined a type of IoT device called an “Actuator Controller.” (404). The device can wire up to two regular motor-driven on/off actuators. Even though the actuators are connected to the “controller circuit” through wire, they are still considered one physical device combined. Once the physical device joins an IoT network, wired or wirelessly, the controller will have one network ID (unique IP address if using Matter protocol) and expose two endpoints representing two actuators (405 and 406). Each actuator is a simple device with on/off capability.

An endpoint is a logical device that is more primitive and “atomic.”

Breaking a complex machine into a collection of endpoints of basic components has many benefits. First, it is easy to model the physical world of things by standardizing the endpoints with a set of “capabilities.” For example, on/off devices can be represented with a Boolean value. A multiple-level device or a sensor can be represented with a number. Secondly, those standardized basic components as endpoints can be combined to build arbitrarily complex machines while the data model is still well-defined and highly structured. Any IoT device can be an aggregation of an arbitrary number of endpoints of any type.

Libertas Thing-App is designed to operate with API on an endpoint level. The developer can use a standardized data model to cover arbitrarily complex IoT interactions.

### 3.1 Endpoint and the Standard Data Model

An endpoint, as a logical IoT device, has some capabilities. In Zigbee and Matter standards, a standard capability is called a “cluster.” For example, an on/off light must have an “on/off” capability.

A cluster may define “attributes” and “commands.” A cluster is analogous to a “class” in object-oriented programming, where an attribute is analogous to a property (or member variable), and a command is analogous to a method (member function). Let's use the on/off cluster as an example.
It defines an attribute “On/Off,” a Boolean variable. “True” represents “On,” and “False” represents “Off.”
It defines several commands.
   The “On” command turns the device on. The “On/Off” attribute is turned to “True” accordingly.
   The “Off” command will turn the device off and change the “On/Off” attribute accordingly.
   The “OnWithTimedOff” command takes an “OnTime” argument. The device will turn on immediately upon reception of the command and will automatically turn off after a period indicated in the “OnTime” argument. This command is crucial for devices such as heaters or sprinklers; otherwise, if the communication is lost after reception of the “On” command, the device will be kept on and may cause damage.

In short, the command in the standard data model may cause attributes to change according to pre-defined transformation in a possible time-dependent manner.

The Matter standard also defined a mechanism called “events.” This is analogous to a call-back function in object-oriented programming.

An endpoint may have more than one cluster (capability).

A physical device may host more than one endpoint.

Part of the work of an IoT standard is to define the standard data model of clusters.

### 3.2 LibertasDevice is Endpoint

Throughout this patent, a “LibertasDevice node” refers to a tree node representing a device endpoint in the user input data, as explained in section 2.3.

LibertasDevice, endpoint, and “logical device” are interchangeable.

As mentioned in section 3.1, a “LibertasDevice” must have some associated clusters. Libertas framework provides API for developers to operate on the cluster data model on a LibertasDevice.

### 3.3 Run Thing-Apps on Physical Devices to Control Endpoints Locally

This invention aims to run Thing-Apps on trillions of physical IoT devices to locally control logical devices as endpoints. As mentioned before, there are numerous benefits to this distributed ubiquitous IoT computing design, including safety, reliability, security, privacy, battery and bandwidth utilization, and ease of management.

Thing-app developers primarily deal with logical devices, i.e., endpoints with certain capabilities and business logic algorithms, as part of user input data. Nevertheless, developers know better about the nature of their Thing-Apps and where the best place is to run them.

A developer can simply designate that a “LibertasDevice” should be better controlled locally. Then, the system will try to deploy the Thing-App code to run on the physical device that hosts the “LibertasDevice” as an endpoint instead of running the Thing-App on the IoT hub.

This design is optimal for Thing-App developers. By simply adding a custom attribute to a LibertasDevice node in the metadata, a developer can indicate that it is “Running Locally.” This can even be transparent to users because they usually don't care where the Thing-App code runs as long as it brings optimal user experience.

In the meantime, the central controller will automatically perform all necessary setups for the user based on the developer's metadata. This invention embodies those setups.

### 4 Why does Interconnectivity Matter?

For IoT systems centered around the cloud or edge, all devices and sensors can connect to the central node. The central controller has enough RAM and storage space to maintain connectivity.

Each IoT device may only be provided with a relatively tiny MCU that, under current conditions, may only offer a few dozen KB of RAM and usable flash storage. Such resources are only sufficient to maintain highly limited connectivity.

Even in a centralized network, the MCU should still be capable of maintaining access control for security and privacy reasons. As long as access controls exist, end-to-end encryption should still be preferred between any two nodes (or IoT devices) with access to one another.

Despite the hardware providing the capability, the entire IoT industry still largely ignores access control, and particularly end-to-end encryption.

Even with end-to-end encryption ignored, an MCU-equipped IoT device still needs to maintain a list of the other devices to which it should be connected.

This kind of “logical linking relationship” is called “binding” in networks such as Zigbee or Thread. In this document, “binding” and “interconnectivity” are used interchangeably. As a simple practical example, an end-user may wish to have a light switch bound to three lights. In this way, when the switch is turned on, the “on signal” will be sent to all three bound devices automatically.

Another example is a battery-powered sensor that only “wakes up” periodically to prolong battery life. When the sensor decides it should send out an updated reading, it may be configured to push the message to a set of predefined peer devices.

Without binding, a device may have to broadcast every message to every other node. Each other node is left responsible for “filtering out” messages that are not targeted to itself. As a network grows to include more nodes, the number of useless messages grows to consume all available bandwidth.

### 5 Central Controller, Hub, and Gateway

In an IoT network as originally envisioned, essentially every physical device can be a controller. However, end-users generally prefer dealing with one central controller, for such reasons as convenience.

The central controller, as presented here, is a particular physical device owned by the system owner. It is the physical device node that has maximum permissible access to other nodes. It is also the node to which other nodes grant maximum possible trust, including all end users.

From a security perspective, the central controller can also be called the “trust center.” The Zigbee security model uses this terminology.

In general, a central controller acts as the primary manager of the private IoT network of the network owner. Example tasks include: adding new devices to a network, removing an existing device from a network, and configuring devices. In addition, through the central controller, the network owner can configure bindings and Apps.

As used herein, a “hub” is a local node connecting to every device to which the end-user has access.

A gateway is a node that bridges more than one network. The networks may have different communication protocols and different wireless technologies. As a result, the different networks may not be able to communicate directly without the gateway.

More importantly, a gateway can work as a bridge between a private IoT network and the Internet in general.

As used herein, a hub can also act as a gateway, between every device on a private IoT network and the Internet.

Usually, the central controller also functions as a hub.

### 6 Interconnection (Binding)

As explained in section 4, “Why does interconnectivity matter?” IoT interconnection contains two types of information: data access permissions and push data flow configuration. Naturally, the interconnection target should be down to the endpoint level instead of the physical device level.

In Zigbee, interconnection is implemented as a mechanism called “binding.” For the sake of simplicity, we use the term “binding” throughout the document to coin interconnection-related terms such as “App binding” or “internal binding,”

The interconnection mechanism is defined in Zigbee (see Zigbee Alliance) and Matter (see Connectivity Standards Alliance) protocols. In practice, interconnection is usually further constrained. For example, binding may be limited to a set of capabilities (called “clusters” in Zigbee and Matter).

Interconnection defines access and data flow. If an endpoint's state changes, it sends a state-update message to every endpoint that subscribes to the data.

In Matter, the security part of endpoint interconnection is called the “Access Control List,” while “Binding” and “Subscription” affect the data push flow for commands and attributes, respectively.

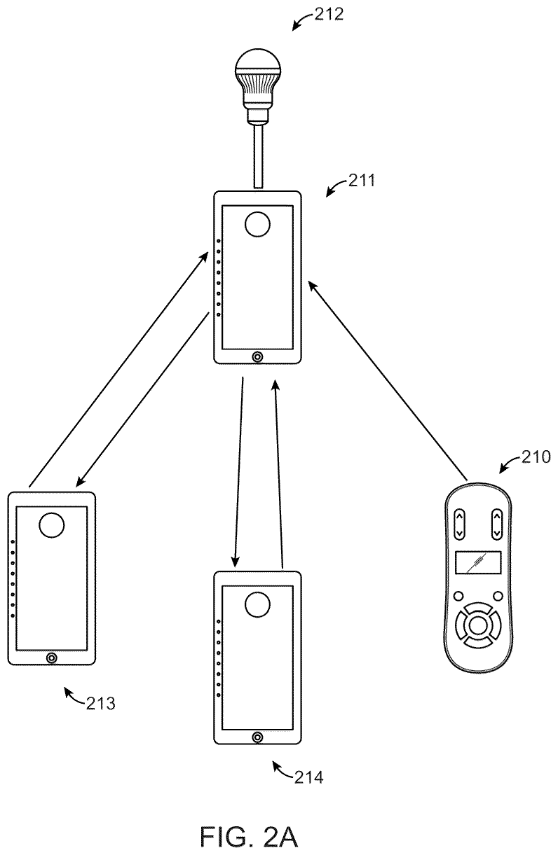

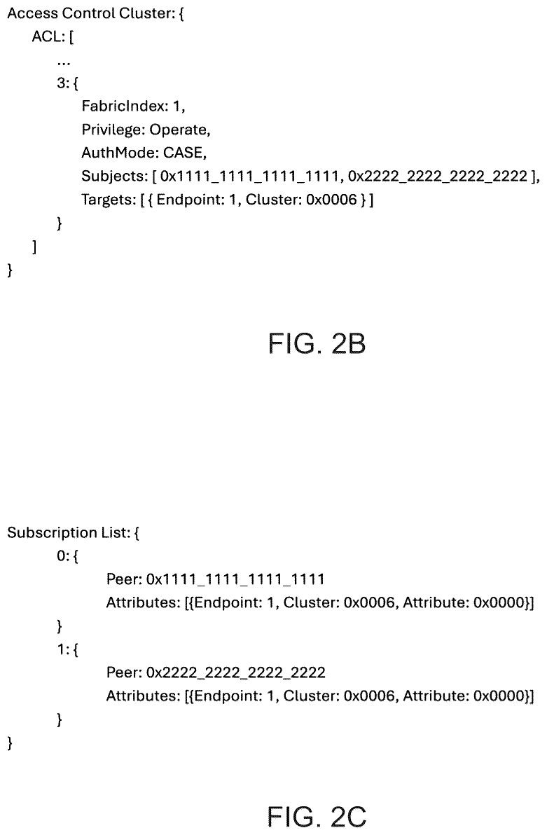

FIG. 2A presents a simple example by which binding can be explained. It is a multi-way light setup with a remote (labeled 210). A “real” light switch 211 has a light bulb 212 as its load. The other two switches (213 and 214) can remotely control the “load switch” 211 from different locations. A remote control 210 can also be used to control the light.

Note: between each remote switch (213 or 214) and the “load switch” (211), there are two bindings: a first going from the remote switch to the load switch and a second from the load switch to the remote switch. The second binding is needed because the remote light switch also has a load of its own: LEDs that can indicate the status of the load. So, every time the status of the load switch (i.e., 211) changes (e.g., from on to off), it sends a status update message to the remote switches (i.e., 213 and 214) to which it is bound.

The remote control 210 does not need a second binding because it was designed not to have a load of its own (to which a message from load switch 211 is sent). This is because the remote chosen is battery powered, and it is desired to keep it powered for as long as possible. The remote 210 only has a first binding, from the remote to the load switch 211, via which a message is sent when the end-user presses a button. To conserve the battery, the remote does not receive an update when the status of load switch 211 changes. So, FIG. 2A shows only a one-way binding (outgoing from remote 210 and incoming to load switch 211).

### Matter Implementation:

Matter separates the session's authentication and authorization. Authentication is done during the “handshake” stage of the session establishment, where the peer's certificate containing the public key can be authenticated by signature from a trusted root certificate. This process is common practice, and we don't need to go into more detail.

Here, we concentrate on the “authorization” part of the Matter standard. First, a Matter device maintains an “access control list” (ACL) in memory. FIG. 2B illustrates an example of an in-memory ACL.
Two peers, with network IDs of 0x1111_1111_1111_1111 and 0x2222_2222_2222_2222, are granted the “Operate” privilege to cluster with the ID of 0x0006 of endpoint 1.
   “Operate” privilege covers both “read” and “write/control” access.
   Cluster 0x0006 happens to be the “On/Off” cluster.
Imagine now peer 0x1111_1111_1111_1111 sends an “On” command to endpoint 1.
   0x1111_1111_1111_1111 has been authenticated during session establish. If the authentication fails, the session won't even be set up, and it won't be able to send commands.
   Once the device receives a command to cluster 0x0006 of endpoint 1, it searches the ACL and discovers permission is granted.
   The device will execute the command and turn on the device.

FIG. 2C illustrates the data push. Suppose both peers (0x1111_1111_1111_1111 and 0x2222_2222_2222_2222) send a subscription request to receive the update of attribute 0x0000 (the On/Off attribute).
The subscription request may only need to be sent once.
The request won't be received until the session is authenticated. Once the request is received, the device will search the ACL for a match and discover that permission can be granted.
The device keeps an in-memory list of subscriptions. If, for any reason, the “On/Off” attribute is changed, a “report” with the changed value will be sent to every peer in this list.

Note the device will follow the simple rule to handle the inbound and outbound messages of the interconnections. It won't care whether the peer 0x1111_1111_1111_1111 or 0x2222_2222_2222_2222 is a human or a running Thing-App task. The behavior will be the same.

### 6.1 Simple and App Binding

In the Libertas system, the interconnection in the example above is called simple binding. It binds several non-load endpoints to a single load endpoint.

Another type of binding, called “App binding,” is between an App task (as executing on an IoT device) and all endpoints in the user input data (unless the context specifically indicates otherwise, using the term App herein should be regarded as another term for Thing-App). The entire set of endpoints in the user input data is called peer endpoints or simply peers. Remember, an endpoint is a LibertasDevice or a logical device.

### 6.1.1 Local App Endpoint

Each physical device can have at least one dedicated endpoint for a Thing-App task that interacts with every “LibertasDevice” endpoint in the user input data (peer endpoints). Such an endpoint is called a Thing-App endpoint.

From a peer endpoint's side, a Thing-App endpoint acts as a protocol standard endpoint. Furthermore, within a single IoT device, despite the limited resources of an MCU, more than one app can run simultaneously.

### 6.1.2 Assignment of App Endpoints

For the sake of complete logic, the system is designed so that, using the standard protocol, the peer endpoint can be unambiguously identified in every message transaction.

For Zigbee protocol, both the source and destination endpoints (including the address of the physical device and local endpoint number) are explicitly encoded in the message. Even if all Thing-App tasks share a single endpoint number, the identity of the peer endpoint is clear in every message.

For Matter protocol, the standard interaction model messages don't include full endpoint information; only the endpoint of the “server” side is included in the message. The messages only include the ID of the physical device of the “client” side. If the Thing-App task only acts as a “client” of peer endpoints, the Thing-App task can still use one shared endpoint to interact with all peer endpoints. However, if a Task also acts as a “server” device, i.e., it receives “requests” from client endpoints, a dedicated local endpoint number must be allocated for that peer endpoint. Still, more than one Thing-App task can share one dedicated local endpoint for the same peer endpoint.

If a Thing-App endpoint is shared across multiple peer endpoints or even multiple Thing-Apps, the Libertas App engine framework implements the mechanism for “multiplexing” in the API calls and data callbacks.

### 6.1.3 App Endpoint Pool

A Thing-App-enabled device can reserve a pool of dynamic endpoint numbers for Thing-App endpoints. Each physical device may have over 65,500 endpoints for Matter standard, enough for the Thing-App endpoint pool.

In this document, the Thing-App task is a client to the peer endpoints. In Libertas, we introduced the “virtual devices” concept for a Thing-App task to act as server endpoints. Each virtual device is a unique endpoint created dynamically with the creation of the Thing-App task. “Virtual devices” is out of the scope of this application.

For both Zigbee and Matter protocols, a single Thing-App endpoint is sufficient to serve as a client to all peer devices and all Thing-App tasks running on that device.

### 6.1.4 Thing-App Endpoint Management

The central controller manages the Thing-App endpoint pool for each physical device capable of running Thing-App tasks.

### 6.1.5 Thing-App Endpoint to Peer Mapping

When a Thing-App task code calls an API that sends a message to a LibertasDevice, the underlying Thing-App engine translates the destination LibertasDevice to the actual physical address and endpoint number.

When the Thing-App task's host device receives a message from a physical device, the underlying Thing-App engine uses the raw message's physical address and endpoint number to translate the source into the corresponding LibertasDevice before triggering the callback routines.

### 6.2 Internal Interconnection and Thing-App Internal Binding

Interconnections can be established among multiple endpoints within a single physical device. For example, multiple buttons on a switch can be bound to a single dimmable light on the same device. Each button may be used to control a different dimmer level.

A Thing-App task can communicate with other LibertasDevices (endpoints) on the same physical device. This type of interconnection is called Thing-App internal Binding.

From a data exchange perspective, internal binding is no different than external binding. Nevertheless, internal binding is (in general) more reliable than external binding, and communication is faster.

The main goal of this invention is to run Thing-App tasks on physical devices and control endpoints locally.

The software SDK should be aware of the internal interconnection scenarios and designed so that the same code can handle communications from both external and internal interconnections. Libertas SDK is provided to programmers to build firmware capable of running random Thing-App tasks locally on a device. A developer uses Libertas SDK to drive device hardware as built-in endpoints as if the device has no Thing-App capability. The final firmware will be linked with a Thing-App engine that transparently drives Thing-App tasks and marshals communications between tasks and regular endpoints (local or remote).

If a device has Thing-App capability, it has Libertas running. The Libertas OS will treat internal interconnections transparently. If a device does not have Thing-App capability, a standard protocol conformant interconnection configuration needs to be set up on the Thing-App peer device. The “AutoBind” algorithm in FIG. 4C describes the algorithm for the central controller to set up such interconnections.

### 6.3 Read/Write Device Access Attributes and Protocol Access Control List

Every device endpoint (also referred to as a “LibertasDevice”) data node can specify an explicit access flag as a meta-data attribute. There are two relevant access flags: “Read” and “Write.” The “Read” flag only allows incoming data from the peer LibertasDevice endpoint to the Thing-App endpoint through data query from the App or push data/command from the peer endpoint. The Write flag only allows outgoing data from the Thing-App endpoint to the peer LibertasDevice endpoint.

The access flag serves two purposes:
1. Access control to the peer device. If the access is only “Read,” the Thing-App can only read the state of the device but cannot control it, which requires “Write” access.
2. Access flags also affect the automatic data flow. If the access is only “Write”, the Thing-App will only send control messages to the peer device. The device will not push the data when the state changes (caused by other agents), thus saving bandwidth.

In Libertas meta-data (or schema), the access attribute in the JSON data has an internal name of “LibertasFieldAccess.”

In Matter protocol, there are three types of accesses:
Read—for attributes and events.
Write—for attributes
Invoke—for commands

The data model defines privileges on each element (attribute, event, and command). Generally,
View privilege required for Read access,
Operate privilege required for Write access,
Operate privilege required for Invoke access for request commands.

The privileges may vary, for example:
An attribute may not be readable or writeable at all
A command usually requires an “Operate” privilege to invoke access, but it may sometimes require a “View” privilege.

A remote device may be granted a View or Operate privilege in the ACL (access control list) or a device:
A remote device granted the “View” privilege may only read attributes requiring the “View” privilege. The remote device cannot invoke commands unless a command defines the “View” privilege to invoke access.
A remote device granted the “Operate” privilege has the read access of the “View” privilege, as well as write access to attributes defined “Operate” privilege to write access and invoke access to commands defined “Operate” privilege.

By default, with Matter protocol:
If the Thing-App access is “Read-only,” a “View” privilege is required.
Otherwise, if the Thing-App access is “Read-Write” or “Write-only,” an “Operate” privilege is required.
There are two other Matter privileges above “Operate”: “Manage” and “Administer.” We defined another attribute to boost from “Operate” privilege to “Manage” or “Administer” privilege. This document only uses the “Operate” privilege as the default value without loss of generality.

Note a matter device can only grant two possible privileges to a Thing-App task, which makes the access control potentially coarser than the ideal. The Thing-App runtime can check the task's runtime access to the peer endpoint.

6.4 Unicast Vs. Multicast

An endpoint sends data to each of its bound endpoints. There are two main ways to send data: unicast and multicast.

Unicast sends a message to one recipient endpoint, while multicast sends one message to a group of recipient endpoints.

Multicast is defined as a “group endpoint,” which consists of a group address and an endpoint.

Sending a few unicast packets is more efficient if only a few bound endpoints exist. However, if there are more bound endpoints than a certain “threshold”, it is more efficient to use multicast. Therefore, we define the threshold as the “multicast threshold.”

### 6.5 Proxy

A device may act as a “proxy” for another device. Usually, the “proxied device” is battery-powered, and the proxy device is full-powered. To save battery life, the proxy provides the network-level and full application functionality on behalf of the battery-powered device.

In practice, a binding to a battery-powered device may result in an actual binding to its proxy device. For simplicity, in this document, we will still focus on the “logical” binding relations among devices and letting the underlying network infrastructure handle such details as a proxy.

In matter standard, Proxy service is part of the core standard specification, though it is still “provisional” at the time of this writing.

6.6 Hub Thing-App Deployment Vs. Device Thing-App Deployment

Nothing likely needs to be changed if the App is deployed to run on a hub, rather than IoT devices, because the hub already has interconnections to all the related nodes' endpoints.

However, if an App is deployed to an actual physical device node (with “Any” or “All” deployment target settings), the interconnections among related endpoints may not exist beforehand; the central controller should automatically configure interconnections between each peer endpoint and the corresponding Thing-App endpoint.

As explained in Section 5, a Hub and central controller are usually the same process on the same machine. However, they are logically two different system components; the Hub is conceptually about connectivity, while the central controller is conceptually about management permissions.

6.7 Translating Thing-App Interconnections into Protocol-Specific Interconnection Configurations

Thing-Apps are designed to be “write once, run everywhere.” They can be deployed inside a device running different IoT protocols and are expected to behave transparently. The Thing-App engine may translate API calls to the protocol-specific data model.

Before the Thing-App task on the device is deployed and started, appropriate binding/interconnections to peer endpoints must be automatically configured first.

Generally, the “LibertasFieldAccess” meta-data attribute of endpoint (LibertasDevice) nodes contains enough information to translate the Thing-App binding into the interconnections of native standard protocols.

Since Thing-App interconnection is more dynamic and sophisticated than simple interconnection mechanisms of protocol standards, the Libertas OS implements mechanisms to optimize the handling of the interaction beyond the standard mechanisms (binding table and access control list) with the same expected security and functional behaviors.

Nevertheless, we always assume the Thing-App peer endpoints are standard protocol-compliant nodes that may not even be capable of running Thing-App tasks. In section 6.2, we explained that Libertas OS also handles internal interconnection. This document focuses on performing standard protocol management operations to configure the interconnection configuration of remote Thing-App peer endpoints.

6.7.1 Interconnections with Peers Running the Same Protocol

From a physical device's perspective, a Thing-App code should be deployed on the device to run with corresponding user input data. Some interconnection configurations must be performed before the task is ready to run. This is done automatically by the central controller because the central controller has all the required data (including the developer's metadata and the user's input data) and the required permissions to perform the remote device configuration. The interconnection configuration should involve at least two factors:
1. Authentication: Unauthorized devices are not allowed to interact
2. Authorization: Configuring access control permissions

For Matter protocol, the authentication uses a public-key certificate during session establishment. If a session is successfully established, the peer is authenticated. For Zigbee protocol, a secret end-to-end link key between two devices must be established for message authentication.

The authorization configuration is different. Below, we use Zigbee and Matter as examples. However, the actual scope of Thing-App binding-induced interconnection is not limited to Zigbee and Matter.

### Zigbee

For a peer endpoint with “read” access, an outgoing binding from the peer endpoint to the app endpoint is added to the peer device's binding table.

For a peer endpoint with “write” access, an incoming binding from the app endpoint to the peer endpoint is added to the peer device's binding table.

### Matter:

For a peer endpoint with “read-only” access, an entry in the peer device's access control list (ACL) is added with the app endpoint as a “subject” node, and “View” privilege is granted. Depending on the device capability (clusters), a binding from a peer endpoint to the app endpoint may be added to the binding table. The app code can always subscribe data from the peer endpoint through API.

For a peer endpoint with “write” access, either “write-only” or “read/write,” an entry in the peer device's access control list (ACL) is added with the app endpoint as a “subject” node, and “Operate” privilege is granted.

As explained in section 6.3, the “Operate” privilege for write-related access may be elevated to a “Manage” or “Administer” privilege with an additional attribute, which is out of the scope of current documentation.

Other IoT protocols usually have a similar direct interconnection mechanism defining security access control and data flow, though the terms may be named differently.

6.7.2 Interconnections with Peers Running Different Protocols

A proxy or bridge can be used for interconnection and protocol translation. On the API level, the Thing-App engine will translate uniform API into protocol-specific data models and transactions so that “write once, run everywhere” can be achieved.

### 7 Security

Bindings do not only define logical relations and data flow among devices. They can also cause changes to the non-volatile configuration of related devices and the network.

Since bound devices automatically talk to one another, the binding configuration operation needs to include satisfactory compliance with security requirements, such as:
1. Ensure the user who causes the binding operation has proper access to all the related devices. Since the client tool cannot be fully trusted either, the check should be performed again in the backend central controller once the request is received.
2. Each IoT device cannot be fully trusted, either. End-to-end encryption can be used to enforce device authentication, and an authorization mechanism such as an access control list can be employed to limit data access from any remote endpoint. Thus, interconnection configuration is part of security practice.
3. The Thing-App engine enforces additional security measures. A Thing-App task can only interact with endpoints in the user input data. The Thing-App engine must implement security measures to ensure the task code only interacts with the LibertasDevice endpoints in the user data and complies with the “read/write” access attribute in the metadata. Also, the Thing-App code can only operate within the allowed capabilities specified in the metadata as part of the “DeviceType” attribute. If the task code accesses endpoints beyond the scope of designated constraints, the code can be terminated for access violation or rejected by the peer endpoint.
4. The central controller automatically performs security checks and sets up all those security measures. The central controller may implement extra confirmation from the user for some more sensitive devices before deployment. For example, a door lock is usually more security-sensitive than a light switch.

### 8 Network Configuration

As for the network configuration, binding may be established among devices within the same network using the same network protocol, or it can be cross-network with different protocols. If a binding happens to be cross-network, an appropriate routing strategy (such as TCP/IP) can be used on a gateway to ensure the traffic can reach cross-network. The traffic can be sent via the gateway, and the unique identification of the destination can be included in the message or (if necessary) inferred from the message itself. If different protocols are involved, when crossing between networks, a protocol translation node or layer can be deployed.

The central controller can automatically configure the required network configuration and ensure the process is transparent to the end users.

### 9 Non-Volatile Memory

Many of the changes to a network or its nodes can be stored in the non-volatile memory of related devices and network nodes. The object of such changes can include a binding list, encryption keys or trusted-certificate-based identities, and an access control list.

If a binding is cross-network, additional information about the binding can be kept in the non-volatile memory of a gateway to ensure messages are delivered properly. Some examples of such additional information include routing information, an identification map, and protocol translation information.

### 10 Deployment Target Meta-Data Attribute

A Thing-App can almost always run inside a hub because:
1. A hub usually has more CPU and memory resources than IoT devices or sensors with a small MCU.
2. A hub, by default, has access (bindings) to all nodes in the IoT network. Running an App inside an IoT device is often more optimal than on the hub.

Part of the present invention is permitting the developer to instruct explicitly, in the meta-data, that an App run on an IoT physical device or on a set of IoT physical devices. In general, developers know best the nature of the app they have created, its resource requirements, and its execution pattern (e.g., power consumption, bandwidth utilization, or both).

Permitting the developer to constrain the execution environment of his or her App is an important part of achieving the design goal of “write once, run everywhere” across billions of devices with different kinds of CPUs or MCUs.

### 10.1 Qualified Devices

For a particular Thing-App, not every IoT physical device is “qualified” to run it. For example, a physical device may not be able to run apps at all, or the device may not have enough resources to run a particular app. (Resources that may be insufficient include CPU capacity, storage, or bandwidth budget.) Capability requirements can be added as attributes to the meta-data. For the sake of simplicity, in this patent, we assume the central controller already knows how to identify qualified devices based on their capabilities.

### 10.2 DeploymentPolicy Attribute

If a developer chooses a LibertasDevice node as a deployment target (for the host physical device to run the Thing-App task), a “DeploymentPolicy” attribute can be specified on its corresponding meta-data node.

There are four kinds of deployment targets:
Any—Any qualified device is a deployment candidate. Only one node is required to deploy the application. Note: if no node is qualified, the hub can be used.
All—The App should be deployed on all qualified devices. Note that the node should be within an array (though not necessarily an immediate member of the array, it can be a decedent of an array). If a node is not qualified to run the App, all such “nodes” can be deployed to the hub.
ForceAny—This is similar to “Any.” The difference is that the deployment fails if no qualified device exists.
ForceAll—Similar to “All.” The difference is that the deployment fails if any node is on an unqualified device.

The Deployment Policy attribute is orthogonal to those permitted entries in the “Meta-Data Editing” or “Argument Editor” of the Prior Applications. See Prior Applications, Sections 5 and 6.

Even though the “DeploymentPolicy” attribute is for the LibertasDevice type of data node, which is an endpoint, the purpose is to run a Thing-App task on the endpoint's “host device,” which is a physical device.

### 11 Massive Deployment (DeploymentPolicy==ALL)

Developers may instruct the platform to deploy the same App task to more than one physical device node provided by the end-user.

The “DeploymentPolicy” of “All” or “ForceAll” are used to specify massive deployment.

Massive deployment is used to deploy Thing-App tasks to many nodes with some shared dependencies (such as shared bound devices and configurations), each node may have its own dependency as user input data.

Massive deployment offers a better end-user experience by improving efficiency in deployment and management.

### 11.1 Input Data Partitioning for Massive Deployment

A Thing-App task deployed to a physical device must interact with all the endpoints (LibertasDevice nodes) in the user input data. After all, if the App is not to access other logical devices, why would the developer or end-user include those logical devices in the configuration data?

We aim to run Thing-Apps inside physical devices and locally interact with the designated endpoints (LibertasDevice nodes in input data). When it comes to running the Thing-App task on multiple physical devices results from one single user input data, each instance of task on the physical device can interact with endpoints local to the physical device while not interfering with the endpoints (in the user input data) that will interact with the tasks on other physical devices. To achieve that, each task running on a physical device must have modified user input data with some nodes “trimmed off.” This process is called “input data partitioning.”

The user input data is highly structured tree data that strictly follows the developer-defined metadata. In most cases, partitioning can be performed automatically. We introduced two attributes for input data partitioning, “AutoPartition” and “DeployRemoveDependencies.” Those attributes apply to a “LibertasDevice” node with “DeploymentPolicy” as “All” or “ForceAll.”

### 11.2 AutoPartition Attribute

For a task on a qualified physical device, the central controller performs the algorithm below to partition user input config tree data with AutoPartition attributes on each qualified device.
1. Keep the endpoints on the task's host device. Traverse the user input tree and collect all LibertasDevice nodes (endpoints) local to the qualified device as “protected data tree nodes.” Note that all the ancestor nodes of the “protected nodes” are also protected because removing the ancestor node will result in the “protected node” being removed.
2. Remove “similar” endpoint nodes on other physical devices with the same Thing-App task deployment. Those nodes should interact with the Thing-App task locally. Traverse the user input tree again. Trim off each LibertasDevice node with “all deployment policy” and “AutoPartition” but not on the host physical device.
3. Aggressively trim off tree nodes. While removing the data tree nodes calculated in step 2, trace through the ancestor trail to the root and remove the furthermost node that can be removed. That is, the furthermost node that is not “protected” according to step 1.

### 11.3 DeployRemoveDependencies

Libertas meta-data is a schema of tree data, just like the schema for XML (see World Wide Web Consortium, or W3C) and JSON (see the Open JS Foundation).

The part of the tree-data instance based on the schema can be represented as a simple search path, just like an XML path (or XPath). In fact, a list of XPaths can be used to represent the nodes to be removed from user data tree for a particular task deployment.

“DeployRemoveDependencies” is an attribute, on a LibertasDevice metadata node with “all deployment”, to partition user input data by the list of paths specified as the attribute's value. Each path follows the specification of XPath, with the following differences.
1. Because most likely a path specification is used to remove the binding to sibling nodes in an array, including the siblings of the nearest parent array, one can use the “sibling::” prefix to represent both the “following-sibling::” and “preceding-sibling::” prefix.

For a task on a qualified physical device, below is how central control partitions user data using “DeployRemoveDependencies:”
1. Keep the endpoints on the task's host device. Like “AutoPartition,” keep local endpoints and all their ancestors as “protected nodes.”
2. Trim off nodes based on the explicit paths. From each protected “LibertasDevice” node on the host physical device, calculate the nodes that should be trimmed off using the paths in the corresponding “DeployRemoveDependencies” attribute. For each node that matches the paths, trim it off if the node is not protected.

### 11.4 “AutoPartition” and “DeployRemoveDependencies”

Both attributes facilitate data partitioning. The goal is to trim some nodes from the user data tree for a task deployed to a physical device.
In most cases, we can't only remove the LibertasDevice tree node. The result data tree must at least comply with the metadata schema. So, in most cases, a node bigger than a single LibertasDevice node is trimmed off.
By definition, the removed node is most likely a member of an array, although in some cases, it is not, and the node's value should be set to “null.”

“AutoPartition” is easier to use; just add that attribute to an “All Deployment” LibertasDevice node. In most cases, “AutoPartition” is sufficient for the central controller to perform automatic partitioning.

“DeployRemoveDependencies” is a little more difficult because the developer must provide explicit paths. However, it is more powerful and covers cases where “AutoPartition” won't work, such as conditional dependencies.

These two attributes can be used together or separately.

If the end-user later modifies some input data that is only related to a single deployed physical device, the central controller will only update the App user data of the affected device while the other device continues to run unaffected.

### 11.5 Selecting Physical Devices as Deployment Targets

For LibertasDevice nodes with the “DeploymentPolicy” attribute set to “All” or “ForceAll,” every qualified corresponding “parent” (or “host”) physical device should run the Thing-App task.

If the “DeploymentPolicy” attribute is “Any” or “ForceAny” and the corresponding LibertasDevice data node is a decedent of a “List (array)” node, there may be more than one physical device that qualifies to run the Thing-App task. We need to pick exactly one device to run the Thing-App task. The user client GUI tool may automatically choose the best physical device to run the Thing-App task based on its capability and location on the network for optimized overall performance. The GUI may also give the end user a choice among several equally optimal devices.

In summary, for “Any” deployment, the deployment target device is selected by an agent, which is a combination of an automated process and the end-user's choice.

### 11.6 Hub Split Deployment

In a massive deployment, some target devices for potential deployment may not be qualified. In other words, there may be devices that cannot run the App. In this case, the app task will be deployed to a hub to communicate remotely with the unqualified devices.

The same partition algorithm will work for such a deployment. The Hub will be the host device of all unqualified LibertasDevice nodes. Those LibertasDevice nodes will be the “protected nodes,” and LibertasDevice nodes on other qualified physical devices should be removed from the data tree.

### 11.7 Pseudocode of the Algorithms

FIG. 4A-4C depicts the pseudocode of data partitioning (for DeploymentPolicy=ALL) and interconnection establishment.

### 11.7.1 User Input Data Partitioning

FIGS. 4A and 4B describe the source code for input data partitioning for LibertasDevice nodes with the “DeploymentPolicy” attribute set to “All.”

### 11.7.2 Automatic Interconnection Setup

FIG. 4C describes the source code for automatically establishing interconnection for a Thing-App task on a physical device.

Below is a list of API calls that appear in the pseudocode:

The “allocateAppEndpoint” function call takes a peer endpoint (node) and its corresponding parent physical device (PD) and returns a dynamically allocated endpoint number for the Thing-App task. The endpoint number can be a new endpoint from the “App Endpoint Pool,” as explained in section 6.1.3, or it can be a shared endpoint from the endpoints already allocated to the same Thing-App task, depending on the protocol standard and the allowed capabilities (clusters) of the LibertasDevice node, as explained in section 6.1.2.

The functions “EnableReadAccess,” “EnablePushDataSubscription,” and “EnableWriteAndOperateAccess” will start protocol-specific transactions from the central controller to the peer device to add corresponding configurations. The peer device will keep the configuration data in non-volatile memory so that the settings will remain effective after reboot from power loss.

### 11.8 Practical Limitations

Matter protocol defines all constraints directly or indirectly related to interconnection as part of the standard, including:
Access Control Limits—The maximum number of entries in the access control list (ACL). Most devices allow only 4.
SubjectsPerAccessControlEntry, TargetsPerAccessControlEntry and SubscriptionsPerFabric. Most devices only allow 3 or 4.
CaseSessionsPerFabric, usually 3. It at least affects the performance.

Suppose we only allow the central controller to run Thing-App tasks. Since the central controller already has administrator access to all connected devices, no extra entry to the peer device is required.

Suppose we want to distribute the Thing-App task to many IoT devices other than the central controller. In that case, these constraints will limit a regular device's capability to serve as a target for too many Thing-App tasks. The constraints' values are part of a device's attribute set that can be queried. The central controller will check the constraints and report the exact failure before the user tries to deploy the Thing-App task.

On the other hand, these practical limitations also indicate that the entire industry never even considered running IoT apps on billions of IoT devices. And the limitations are easy to overcome. After all, a 4 KB page of a device's internal flash memory can hold hundreds of ACL entries. The limitation can be lifted through a firmware upgrade over the network.

### 12 An Example

The example is an algorithm to control actuators based on sensors and some configuration data.

There is one Global_Sensor and Global_Config that is shared by all actuators.

Also, there may be many Local_Sensors shared by a relatively smaller group of actuators. Each Local_Sensor comes with a Local_Config.

Each actuator comes with an Actuator_Config.

This app is an example of massive deployment.

The goal is to run the App inside every Actuator. The App code controls the Actuator based on data from sensors to which the Actuator is linked, along with corresponding config data. A Global_Sensor and Local_Sensor are logically linked to an Actuator.

### 12.1 the Code and Metadata

FIG. 4D depicts the definition part of the code on the left side. It shows the declaration of two classes (at lines 1 and 6) and the declaration of the App entry function (at line 15). Note: there are type cross-references in the class declarations and the function declaration.

The Libertas IDE development tool automatically generates the metadata of user input data using the class definitions in the source code. During runtime, the Libertas framework marshals the user input data as the input arguments of the function ActuatorsControl, which serves as the entry function of the Thing-App task. On the right side of FIG. 4D, we list the additional attributes added by the developer to each metadata node on the source code level.

FIG. 4E depicts an actual GUI tool, the metadata editor. The left side presents the metadata from the source code, and the right side presents the additional attributes, the same as the right side of FIG. 4D.

Some attributes in this example are solely for UI optimization, such as the “Header” attribute. Others will affect UI and data constraints, such as “Unique” and “Minimal Size.”.

In this example, we focus on the attributes of meta-data nodes of the LibertasDevice type.
The “DeviceType” attribute contains additional constraints about the device, such as its type and capabilities (clusters). It limits the user's choice when prompted to choose a LibertasDevice from the UI and serves as additional constraints for interconnection by only allowing specific cluster messages through the interconnection.
The “Access” attribute is used for security checks and interconnection direction.
“DeploymentPolicy” indicates the Thing-App code should run on devices to communicate locally. FIG. 4F emphasizes what changes a single “DeploymentPolicy” attribute can make!
“AutoPartition” and “DeployRemoveDependencies” attributes affect the partitioning of the “DeploymentPolicy=ALL” setup.

FIG. 4F also demonstrates how the “DeviceType” attribute is edited using our GUI tool. The programmer clicks the area 404 to bring out a GUI dialog box. The developer can then specify the “Device Type” (405) and “Cluster (Capability)” of the device meta-data node (406). In this example, the developer chooses the device type of “Actuator” with “On/Off” cluster from the GUI.

### 12.2 the Example Hardware Parts List

FIG. 4G presents an example parts list.

### 12.2.1 Actuator Controller

The actuator controller connects to the IoT network, wired or wirelessly. Each controller connects to up to two regular on/off actuators. Each actuator is an independent endpoint on the physical controller.

This example has four actuator controllers, each with two actuators.

The actuator controllers are named AC1 through AC4, and the actuators are named Actuator1 through Actuator8 by the system owner.

We assume that each actuator controls the damper of one room. “Actuator1” through “Actuator4” are on the first floor, and the rest are on the second floor.

### 12.2.2 Sensors

There are three temperature sensors. “Global_Sensor” is located outside of the building. “Local_Sensor_1” is on the first floor, and “Local_Sensor_2” is on the second floor. In this example, we only care about those sensors as endpoints. Their parent physical devices are irrelevant.

### 12.3 Running Code on Each Actuator Controller Device

The developer aims to run Thing-App tasks on the “actuator controller” devices in this example. The Thing-App code on each controller will communicate with the corresponding global and local sensors remotely while controlling the actuators internally.

The developer only needs to add one more attribute to the “Actuator” metadata node, the “DeploymentPolicy” attribute (401). Without that attribute, the Thing-App tasks will run on the Hub by default. In this example, we want to run the same Thing-App tasks on every Actuator controller device, so the value of the “DeploymentPolicy” attribute is “ALL.”

For multiple device deployment, we will need at least one more attribute to indicate how to partition the user input data. Either “Auto Partition” (402) or “DeploymentRemoveDependencies” (403) will work in this example.

### 12.4 Example User Input Data

FIG. 4H1 shows an example of user input data with the example part list.

FIG. 4H2 depicts the relationship between each user input tree node and the metadata tree node on the source code.

### 12.5 the User Interface

Based on the metadata, the Libertas frontend software, such as a smartphone client, automatically generates the UI for the user to create the input data tree.

FIGS. 4J through 4X demonstrate how the UI works step-by-step. The dotted arrow line indicates the order of the UI transition.
In FIG. 4J, at the start of the UI, the “Global_Sensor” (450) and “Global_Config” (451) fields are automatically populated.
In FIG. 4K, the user presses 450 and brings up the UI to choose a temperature sensor. The user should choose the “Global Sensor” (452). Press 451 will bring up a UI to edit the config, which is a string. We omit the UI without loss of generality.
In FIG. 4L, the user has configured the first two nodes, the “Global_Sensor” (450) and “Global_Config” (451).
In FIG. 4L, the user presses “Add Local_Group” (453) to add the first local group.
In FIG. 4M, a first “Local_Group” is created and automatically populated on the UI. The “Local_Group” is in an array and is automatically named “Local_Group [0]” by the UI (454). The corresponding “Local_Sensor” (455) and “Local_Config” (456) require user action to give values, which is indicated on the UI.
In FIG. 4N, the user presses area 455 and brings up the UI to choose a temperature sensor. In this case, the user chooses “Local_Sensor_1” (457). Note some additional information about the endpoint can be displayed on the UI to help the user choose. Again, we omit the UI for “Local_Config”.
FIG. 4P depicts the user has successfully configured the values of 455 and 456.
In FIG. 4P, the user presses “Add ActuatorControl” (458) to add an actuator.
In FIG. 4Q, an “ActuatorControl” (459) is added and populated on the UI. The “Actuator” (460) and “Actuator_Config” (461) are blank and require user action.
In FIG. 4R, the user presses area 460 to bring up the UI to choose an actuator. In this case, the user chooses “Actuator1” (462).
FIG. 4S depicts the user has successfully configured the value of 460 and 461.
In FIG. 4S, the user presses “Add ActuatorControl” (463) again to add another actuator to the group.
In FIG. 4T, another “ActuatorControl” is created and populated on the UI. The UI automatically named the node “ActuatorControl [1]” (464). Again, the “Actuator” (465) and “Actuator_Config” (465) are blank and require user action.
In FIG. 4U, the user presses area 465 in FIG. 4T and brings the UI to choose another actuator, in this case the user chooses “Actuator2” (467).
In FIG. 4V, the user repeated the above process to add and configure two more actuators, “Actuator3” and “Actuator4.” Now, it's time to add another “Local_Group” for the second floor. The user presses area 468, “Add Local_Group.”
In FIG. 4W, a new “Local_Group [1]” (469) is added and populated by the UI. The user can choose a “Local_Sensor” (470) etc.
In FIG. 4W, the screen is automatically scrolled to make the current working nodes visible. The user can also manually scroll the screen to navigate to any node and make modifications.

### 12.6 the Partitioned User Data

In this example, there are four physical “Actuator Controller” IoT devices, AC1 through AC4. The example user data will result in Thing-App task code running on those four physical devices, each controlling two actuators locally.

Each “Actuator Controller” also needs to get data from the related sensors.

Libertas central controller will automatically perform data partitioning based on the metadata and user input data, and automatically establish interconnections among related endpoints during deployment.

FIG. 4X shows the partitioned input data for each actuator controller. Also, in FIG. 4X, the resulting interconnections between Thing-App endpoints and LibertasDevice endpoints are shown.

### 12.7 Simulation of the Data Partition Algorithm

We simulate the data partitioning algorithm in FIG. 4A and FIG. 4B with the user input data from FIG. 4H1. For this example, the “AutoPartition” attribute is sufficient to produce the desired result. As we discussed in section 11, the “AutoPartition” and “DeployRemoveDependencies” can be used either independently or combined. Without loss of generality, we first simulate the algorithm with “AutoPartition” alone, and then we simulate it with “DeployRemoveDependencies.”

12.7.1 Simulation with “AutoPartition” Alone

We assume the “AutoPartition” attribute is specified for “Actuator” metadata node.
Line 1 the function entry, the input is a data tree “dt”, as shown in FIG. 4A.
Line2 creates the result list of partitions as a list of tuples [PhysicalDevice, DataTree]
Line 3 creates a set of qualified physical devices.
Line 4-8 traverses the input data tree dt and passes every node to the anonymous function that takes a DataTreeNode. The function identifies qualified physical devices and adds them to the set. Obviously, only Actuator data nodes pass the test in line 5 and reach line 6.
After Line 8, the set qualifiedPhysicalDevices contains four physical devices in FIG. 4X, AC1 through AC4.
Lines 9-54 iterate each of the four physical devices and generate partitioned input data for each physical device.
Note the input data dt is cloned into a new partitionedDataTree in line 10. The partitionedDataTree will be modified by trimming off some nodes.
Let's assume the first physical device node iterated (curQualified) is AC1, which contains Actuator1 (413) and Actuator2 (415).
Line 14-31 is a tree traversal. Only 8 Actuator nodes made it to line 16.
Lines 17-24 are for Actuators local to the curQualified physical device. In this case, Actuator1 (413) and Actuator2 (415) will pass through lines 17-24.
Lines 17-20 will collect the protected nodes set.
   When node==413, nodes 413, 412, 411, 410, and 409 are added to protectedNodes set
   When node==415, nodes 415,414, 411, 410, and 409 are added to the protected nodes set. Note nodes 411, 410, and 409 are already in the set.
After line 31, the protectedNodes set contains 409, 410, 411, 412, 413, 414, 415.
Since this example demonstrates “AutoPartition”, the test in line 22 will fail. Line 23 is never called. “pathTrimRefNodes” set is always empty.
Lines 26-28 will be executed with Actuaor3-Actuator8, namely nodes 417, 419, 423, 425, 427, and 429. These nodes will be in the autoParRemoved set.
Lines 32-40 trim off nodes based on autoParRemoved set. The code iterates through autoParRemoved set.
Let's assume the first node iterated is node 417.
   At beginning curRemove=417
   The parent of 417 is 416, 416 is not in protectedNodes set, so curRemove=416
   The parent of 416 is 411, 411 is in protectedNodes set. The loop exists with curRemove stays equal to 416.
   Node 416 is removed from data tree
Assuming the next iteration is node 419.
   Similar to the node 417 case, the node 418 is removed in this iteration.
Assuming the next iteration is node 423.
   Line 35-37 keeps exploring ancestors of node 423, until it reaches curRemove=420. The parent node of 420 is 409, which is in protectedNodes set.
   The entire tree trunk of node 420 is removed.
The rest of the nodes, 425, 427, 429 are already removed under node 420, nothing further is done.
The partitioned data tree for AC1 is then produced.
Repeat the process to produce the partitioned data tree for AC2, AC3, and AC4.
   12.7.2 Simulation with “DeployRemoveDependencies”

Assuming the “AutoPartition” attribute is not set. The “DeployRemoveDependencies” is used instead. The developer must specify the paths along with the attribute. In this example, two paths are specified.

Now, let's simulate the “Deploy RemoveDependencies” attribute.
After Line 8, the set qualifiedPhysicalDevices contains four physical devices in FIG. 4X.
Line 9-54 iterates each of the 4 physical devices and generates partitioned input data for each physical device. Let's assume the first physical device node iterated (curQualified) is AC1, which contains Actuator1 (413) and Actuator2 (415).
Line 14-31 is a tree traversal. Only 8 Actuator nodes made it to line 16.
Same as “AutoPartition” case. After line 31, the protectedNodes set contains 409, 410, 411, 412, 413, 414, 415.
This time, we simulate “DeployRemoveDependencies”
   pathTrimRefNodes contains nodes 413 and 415 (Actuator1 and Actuator2).
   autoParRemoved set is empty
      Lines 32-40 will not be triggered.
Lines 41-51 will trim nodes based on path TrimRefNodes
   Assuming in the first iteration curTrimRef=413
      Lines 43-45 collect nodes from search paths
      First search path “ . . . /sibling::”
         Add nodes 414, 416, and 418 to filteredNodes set
      Second search path “ . . . / . . . / . . . /sibling::”
         Add node 420 to filteredNodes set
      After line 45, filteredNodes contains nodes 414, 416, 418, 420
      Lines 46-50 try to remove nodes in filteredNodes
         Nodes 416, 418, and 420 are removed.
         Node 414 is in protectedNodes and not removed.
   Next iteration curTrimRef=415
      Lines 43-45 collect node from search paths
      First search path “ . . . /sibling::”
         Only node 412 remains and is added to filteredNodes set
      Second search path “ . . . / . . . / . . . /sibling::”
         Note node 420 is already removed, nothing is added
      Lines 46-50 try to remove nodes in filteredNodes
         Only 412 is in the set, but 412 is in protectedNodes so nothing is removed
The partitioned data tree for AC1 is then produced.
Repeat the process to produce the partitioned data tree for AC2, AC3, and AC4.

### 12.8 Robustness of Data Partition Algorithm

In this example, if the end-user later modified the local config data of a single actuator, only the input data of that actuator is modified. So, the central controller will only update the App user data of the affected actuator controller while other actuators will keep running unaffected.

### 12.9 Simulation of Automatic Interconnection Algorithm

The IoT central controller automatically performs the interconnection configurations when an end-user deploys a Thing-App task. FIG. 4C shows the algorithm's pseudocode with the entry function “AutoBind.” The “AutoBind” function takes two arguments. The first is the user input data tree, and the second is a physical device used to run the Thing-App task. For the “Any” deployment type, the data tree is the same as the tree from the end-user, and the physical device is selected according to section 11.5. For “All” deployment, the user data tree and physical device are calculated using the data partition algorithm in section 11.

Let's use the upper left quarter of FIG. 4X to simulate the algorithm.

The first argument is the user data tree, which is depicted in the upper part of the diagram. The second argument is a physical device; in this example, it is the device “AC1” on the diagram.
Lines 3-25 traverses every node in the user data tree and passes the node to an anonymous function in lines 4-24.
Line 4 tests that the node must be a “LibertasDevice” type node and must be on a remote device (not on AC1). Only nodes “Global_Sensor,” “Local_Sensor_1” on the tree will pass. Note that “Actuator1” and “Actuator2” are endpoints on AC1; they will be handled by Libertas OS running on AC1.
The controller automatically configures the standard protocol-based interconnection on devices “Global_Sensor” and “Local_Sensor_1.” The actual configuration may be slightly different for different protocols, but in principle, they are about authentication and authorization.
Since the Thing-App task runs on the same physical device with two actuators, the interconnection bindings are internal, and the reliability is vastly improved with other benefits.

### 12.10 Additional Example Data

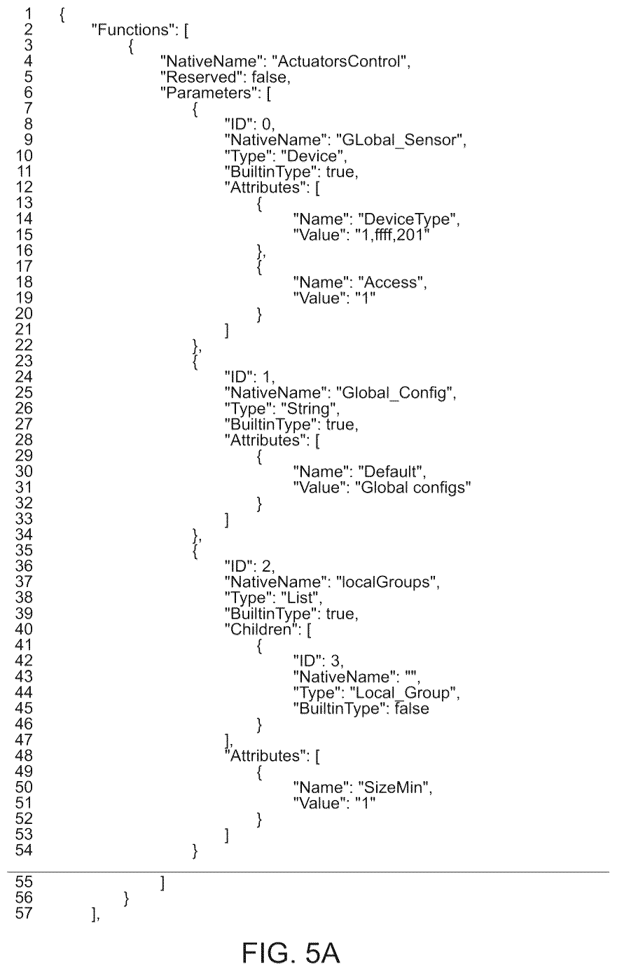

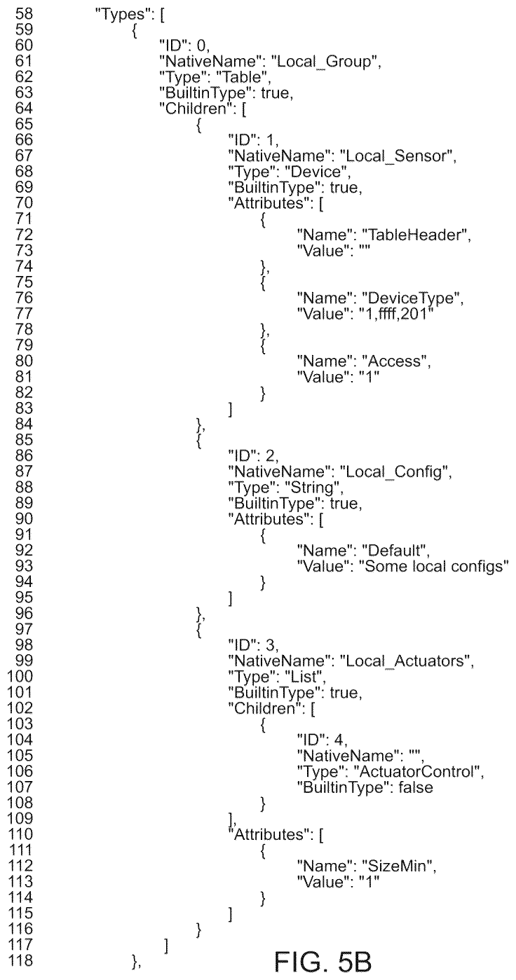

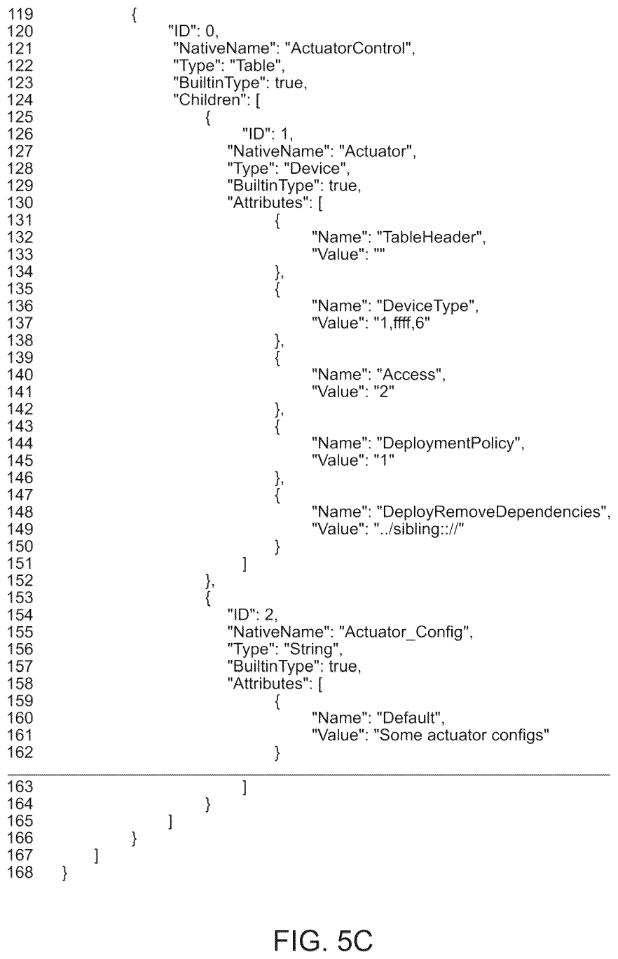

FIGS. 5A-5C depict the internal representation of the metadata in JSON format.

### 13 Every IoT Application can be a Thing-App

Apps have dominated the smartphone world. On an Android or iPhone, every functionality is an App. Even dialing a telephone number is an App that can be replaced.

Libertas Thing-App design is a universal platform that expands to everything with a CPU that can be hundreds of times less powerful than smartphone CPUs. As a result, IoT devices are equivalent to personal computers in the 80s and 90s. Libertas is the operating system on IoT chips that enables Apps from millions of developers. Apps enable free interaction among arbitrary types of devices, relying on the imagination of millions of App developers instead of a vendor lock-in. Even for those “single products” such as thermostats or sprinkler controllers, the Thing-App architecture has a vast advantage over current vendor lock-in practices.

A modern programming language such as Rust offers safety guarantees by design and the performance of C language. So, there is really no obvious downside to adopting Thing-App as a universal IoT application model.

### 14 Additional Information

### 14.1 IoT Device

As used herein, an IoT device is a physical device that, through the provision of an embedded computer system and network connectivity, becomes remotely accessible. The remote access can be for purposes of instructing the physical device (remote control), acquiring information from the physical device (remote sensing), or both.

The power of such IoT devices has typically arisen from their ability to interoperate with each other, in new and often unforeseen ways, under the direction of a remotely-located general-purpose computing platform (the “IoT controller”). By adding new software to the IoT controller, a new behavior can emerge, from the IoT devices with which it is connected. For example, such interoperability can often be characterized as remote sensing, from one or more IoT devices, causing, under the direction of an IoT controller, changes in the remote control of one or more IoT devices.

While possessing network connectivity, an IoT device does not need to include the capability of connecting to the Internet on its own. For example, it is often the case that the end result to be achieved, by software executing on an IoT controller, can be accomplished with IoT devices that are all located at a common deployment location. For at least this reason, it is often the case that the IoT device itself only possesses LAN connectivity. If the IoT controller is also located at the deployment location, it can be the case that an entire IoT system is created which lacks Internet connectivity. However, it is almost always the case that an IoT system includes, at some part of the system, at least one Internet connection.

While an IoT device can achieve its network connection using non-IoT LAN networking protocols, such as Ethernet or the 802.11 suite of protocols, in the context of an IoT device, such LAN protocols often involve significant disadvantages. For example, a non-IoT LAN protocol can possess any combination of the following disadvantages:
require hardware that consumes an excessive amount of power;
require hardware too expensive for incorporation into the device in an economically-viable way;
provide connectivity with an unacceptably low level of reliability;
is not designed to accommodate a sufficient number of devices with simultaneous network connectivity.

For these reasons, and others, the LAN to which an IoT device connects is often specialized to the needs of IoT-type systems. Such IoT-LAN protocols typically possess at least some combination of the following advantages:
low-power;
inexpensive hardware;
high reliability;
accommodate a large number of simultaneously-connected devices.

In order to achieve these advantages an IoT-LAN protocol can often leverage certain requirements that are easier to achieve than those for which non-IoT LAN's were designed. These advantages can include, at least, any combination of the following:
low-speed connectivity;
small message size.

Example IoT LAN protocols based on wireless connectivity include the following:
6LoPAN (RFC 4944, and related, of the Internet Engineering Task Force, Freemont, CA, USA),
Bluetooth (Bluetooth Special Interest Group, Kirkland, WA, USA).
Matter (https://csa-iot.org/)
ZigBee (ZigBee Alliance, Davis, CA, USA), and
Z-Wave (Z-Wave Alliance, Freemont, CA, USA).

An example IoT LAN protocol that uses both wired (powerline wiring) and wireless connectivity is Insteon (SmartLabs, Inc., Irvine, CA, USA).

An example of a particularly common IoT device is an IoT device that replaces the ordinary wall-mounted light switch. In contrast to the ordinary wall switch, which simply opens or closes an electrical circuit as a result of mechanical user input, the IoT wall switch has the following two capabilities:
It becomes a remote sensing device. Specifically, the remotely-located IoT controller can detect whether the switch is in the “on” or “off” position, or receive the on/off state change notification in real time.
It becomes a remote controlled device. Specifically, the remotely-located IoT controller can instruct the wall switch, to either open or close the electrical circuit to which it is connected.

For purposes of backwards compatibility, and to provide protection against temporary interruptions in an IoT-based service, it is often the case that an IoT device will offer a level of local control. For example, for an IoT wall switch, setting its switch to the “on” position will typically cause completion of the electrical circuit to which it is connected, without the involvement of an IoT controller. However, such local control is typically implemented as simply an additional, and parallel, control path. For example, even if the light, electrically powered by an IoT wall switch, has been turned “on” as a result of its switch being put in the “on” position, subsequent signals from the IoT controller can still toggle the light between “on” and “off” states.

IoT devices are interconnected to enable interaction. Devices running the same or different protocols can interconnect with hubs, routers, or gateways. Client software can be provided as a human interface to communicate with all connected IoT devices the user has access to.

For example, by executing an appropriate app, a smartphone can act as if it is an IoT “switch.” Under such circumstances, for example, successive tappings, on a “button” on the smartphone's screen, can be sensed, by software executing on an IoT controller, as the opening or closing of a switch.

### 14.2 Computing Equipment

In accordance with what is ordinarily known by those in the art, an IoT Controller can be implemented through the use of any suitable computing hardware. Suitable hardware can include the use of one or more general purpose computers or processors.

The Application Store can be implemented as a web server. As is known by those in the art, a web server can be implemented through the use of any suitable computing hardware. Suitable hardware can include the use of one or more general purpose computers or processors. Such processors or computers can be dedicated, or, as has become popular in more recent years, their use can be leased through a variety of “cloud computing” service providers.

Each end-user or developer can interact, with a Controller or Application Store, from a web-based interface executing upon a suitable client computer. Suitable hardware for a client computer (including a Smartphone) can include the use of one or more general purpose computers or processors.

Hardware implementation techniques can include the use of various types of integrated circuits, programmable memories (volatile and non-volatile), or both. Computational hardware, whether in integrated circuit form or otherwise, is typically based upon the use of transistors (field effect, bipolar, or both), although other types of components (e.g., optical, microelectromechanical, or magnetic) may be included. Any computational hardware has the property that it will consume energy, as a necessary part of being able to perform its function. Also, regardless of how quickly it can be made to operate, computational hardware will require some amount of time to change state. Because of its basis on physical devices (electronic or otherwise), computational hardware, however small, will occupy some amount of physical space.

Programmable memories are also often implemented in integrated circuit form, and are subject to the same physical limitations described above for computational hardware. A programmable memory is intended to include devices that use any kind of physics-based effects or properties, in order to store information in at least a nontransitory way, and for an amount of time commensurate with the application. The types of physical effects used to implement such storage, include, but are not limited to: maintenance of a particular state through a feedback signal, charge storage, changes to optical properties of a material, magnetic changes, or chemical changes (reversible or irreversible).

Unless specifically indicated otherwise, the terms computational hardware, programmable memory, computer-readable media, system, and sub-system, do not include persons, or the mental steps a person may undertake.

For any method, procedure or technique described above, to the extent it is implemented as the programming of a computer or other data processing system, it can also be described as a computer program product. A computer program product can be embodied on any suitable computer-readable medium or programmable memory.

The kind of information described herein (such as data and/or instructions), that is on computer-readable media and/or programmable memories, can be stored on computer-readable code devices embodied therein. A computer-readable code device can represent that portion of a memory in which a defined unit of information (such as a bit) can be stored, from which a defined unit of information can be retrieved, or both.

### 14.3 High-Level Data Partition Algorithms

Apart from the detailed partition algorithms in section 12, here is the outline of high-level algorithms.

### 14.3.1 Prerequisites

Both data partitioning algorithms need to collect the set of “qualified physical devices.”
1. We define a user tree data node as a “qualified endpoint” if the tree node is a “LibertasDevice” node with the “DeploymentPolicy” attribute value of “ALL.”
2. Traverse the user data tree and collect the physical devices that contain any “qualified endpoint” in the user data tree as “qualified physical devices.”

Using the example data in FIG. 4H1, there are eight “qualified endpoints” from Actuator1 to Actuator8. By traversing the data tree, we can collect the set of four “qualified physical devices” that contain those actuators, from AC1 to AC4, as shown in FIG. 4X.

### 14.3.2 Auto Partition Algorithm

1. For each qualified physical device, referred to as the “current physical device,” clone the original user data tree as the “current working data tree.”
2. Perform a depth-first traverse of the “current working data tree.” For each tree node N,
   a. If N and any descendant of N is not a “qualified endpoint,” we keep N.
   b. Otherwise, N or some descendant of N must be a “qualified endpoint:”
      i. If N or some descendant of N is a “LibertasDevice” node local to the “current physical device,” we keep data node N.
      ii. Otherwise, we remove node N.
         Using the example data in FIG. 4H1, we demonstrate the algorithm using the first qualified physical device, “AC1.” Please note that “AC1” contains two endpoints, “Actuator1” and “Actuator2.”
Perform a breadth-first traverse of the data tree in FIG. 4H1.
The first two nodes are 407 and 408; they are not “qualified endpoints” and have no descendants, so we keep the nodes. (rule 2-a).
The third node is 409. It has a decedent node 413, which is “Actuator1.” According to rule 2-b-l, we keep the node.
The next two nodes are 430 and 431; we keep the node (rule 2-a).
The next two nodes are 411 and 412. They have a decedent 413, which is “Actuator1.” According to rule 2-b-l, we keep the node.
The next node is 413, it is “Actuator1.” According to rule 2-b-l, we keep the node.
The next node is 432. According to rule 2-a, we keep it.
The next two nodes are 414 and 415. Because “Actuator2” is also on “AC1”, we keep them (rule 2-b-i).
The next node is 433. According to rule 2-a, we keep it.
The next node is 416. Because “Actuator3” is not on “AC1,” we remove the node (rule 2-a-ii).
Because node 416 is removed with its children, the next node is 418. Because “Actuator4” is not on “AC1,” we remove the node (rule 2-a-ii).
The next node is 420, because “Actuator5”, “Actuator6”, “Actuator7”, “Actuator8” are not on “AC1”, we remove the entire node 420 (rule 2-a-ii).
The partitioning for the physical device “AC1” is complete.

Repeat the process to partition data for physical devices “AC2,” “AC3,” and “AC4.”

### 14.3.3 “DeploymentRemoveDepedency” Partition Algorithm

1. For each qualified physical device, referred to as the “current physical device,” clone the original user data tree as the “current working data tree.”
2. Traverse the “current working data tree” and collect all “qualified endpoints” local to the “current physical device” as “local endpoints.”
3. For each “local endpoint,” referred to as the “current local endpoint,” calculate the matching data tree nodes with the paths from its “DeploymentRemoveDepedency” attribute from the “current local endpoint” against the “current working data tree,” as “remove candidate nodes.”
4. For each “remove candidate node” N:
   a. If N or some descendant of N is a “LibertasDevice” node local to the “current physical device,” we keep data node N.
   b. Otherwise, we remove node N.

Using the example data in FIG. 4H1, we demonstrate the algorithm using the first qualified physical device, “AC1.” Please note that “AC1” contains two endpoints, “Actuator1” and “Actuator2.”

After step 2, the “local endpoints” to “AC1” are node 413 and node 415 (“Actuator1” and “Actuator2”).

In step 3, let's first take node 413 to calculate “remove candidate nodes.”
Matching nodes with path “ . . . /sibling::” from node 413, we have matching nodes 414, 416, 418.
Matching nodes with path “ . . . / . . . / . . . /sibling::”, we have matching node 420.
The “remove candidate nodes” set will be nodes 414, 416, 418, and 420.
Node 414 has a descendant 415 (Actuator2), which is local to “AC1”, we need to keep it. Nodes 416, 418, and 420 shall be removed.

We then take node 415 to calculate “remove candidate nodes.”
Since many nodes have been removed, with path “ . . . /sibling::” from node 413, the only matching node is 412.
But node 412 has a descendant 413 (Actuator1), which is local to “AC1”. We need to keep it.
The partitioning for the physical device “AC1” is complete.

Repeat the process to partition data for physical devices “AC2,” “AC3,” and “AC4.”

### 14.4 High-Level Interconnection Configuration Algorithm

The high-level interconnection configuration algorithm:
1. The physical device that hosts the Thing-App task is called the app-host device.
2. Traverse the task's user input data and collect all LibertasDevice data nodes (endpoints) as the set of “Thing-App peer endpoints.”
3. Traverse the “Thing-App peer endpoints” set, if an endpoint is on a remote device (not the app-host device since the app-host device handles internal connections), then configure the remote device to allow certain interactions from the app-host device on the endpoint based on the “read, write” access flags.

### Glossary of Selected Terms

application or App: Unless the context specifically indicates otherwise, used herein to refer to an item of application software, written by a developer for use by an end-user.
CPU: Central Processing Unit.
Deploy: Assign an instance of an App to execute on a qualified physical device.
developer: The entity responsible for the computer programming resulting in the creation of an application.
Device Set: The relatively small subset of IoT devices available to any particular end-user.
end-user: An entity acting in the role of actually using an application. Can be the same entity as the developer.
entity: As used with respect to the definition of “end-user” and “developer,” can be an individual person, a group of persons, or an organization (e.g., a corporation, company, or association).
EndPoint/Logical Device: A logical node to which an IoT App communicates. It resides within a Physical Device and has a unique logical address used by the IoT App.
GUI: Graphical User Interface.
Independent Instance: A Thing-App process, in the Libertas OS, which can comprise the App code, App function name (entry function), and values of the App function arguments (as user data created by an end-user with automatically generated UI from the App's metadata). App code can be shared by multiple instances based on the same App as a read-only memory block.
IoT: internet-of-things.
IoT device: see “Additional Information” section.
Libertas App (or “App”): Automation program that enables deployment and interconnection among the nodes in an IoT network.
Libertas Data Tree (or “data tree”): Hierarchical tree of nodes, in accordance with meta data, created by the end-user interacting with the automatically generated data editor GUI from meta data.
LibertasDevice: An EndPoint that supports the Libertas API (may or may not be qualified to “host”). It is hosted by a Physical Device. E.g., sensors and actuators.
Local EndPoints: In the Host Physical Device running the Libertas App. Example: Actuators are local because they don't have to go over network to talk to device.
Meta Data: Data fields associated with a Libertas App to permit the Developer to customize the App's deployment of instances of the App across the IoT network.
Physical Device: A physical embodiment directly connected to an IoT network with a unique network address. A Physical Device may have one or more Logical Devices or EndPoints.
Qualified Device/Qualified Physical Device (or “QPD”)/Qualified EndPoint:
   Algorithms of FIG. 4A-B actually do the deployment (find minimum partition for QPD).
   Physical Device with the resources and capabilities to be a Host such that it can locally run a specific Libertas App.
   Its attribute in the Data Tree (as built by the end-user) has a DeploymentPolicy of ALL or ANY (ALL or ANY set by meta data-tree). Having such DeploymentPolicy means that the central controller knows an App instance could be deployed to it.
Remote EndPoints: In other Peer Physical Devices. Example: For sensors do have to go over network and FIG. 4C makes the connection.
task: An instance of an end-user-selected IoT application (or App) that is actually executing upon an IoT Controller, hub, or device.
UI: User-interface.

### 15 Appendix

This Appendix is essentially the entirety of the written description of the following PCT patent application:

“Method and Apparatus for Managing Ad-Hoc User-Centric Interconnectivity of Internet of Things with Apps,” filed 2023 Jul. 7 (y/m/d), having inventor Qingjun Wei and App. No. PCT/US2023/027117.

### 15.1 Introduction

Patentee has prior applications which focus on an Internet of Things (IoT) central controller, and related tools. The tools address application development and deployment. First, a Meta-Data Editor permits a developer to specify meta-data. The meta-data then guides the structure of actual data entered by the end user.

Once an application is developed and has undergone a test deployment, the developer can upload the application to an online “IoT Application Store,” from which the application can be downloaded and deployed by others. An Argument Editor (or “Data Editor”) permits an end-user to create his or her own data, in accordance with the developer's meta-data, that adapts the execution to his or her particular needs.

For the present invention (also referred to herein as the “Libertas system” or simply “Libertas”), the meta-data has been augmented with new attributes. Such new attributes can be passed to the application when invoked as a particular execution (or process or task) for a particular end-user.

The developer may designate an IoT device type as the App's deployment target. A particularly suitable IoT device type being data nodes. Such designations become active once a new deployment request is received from an end-user with his or her end-user-created data. In response, the central controller can perform the following steps:
Automatically select a set of IoT devices and sensors as “qualified” deployment targets. (See below for definition of “Qualified node.”)
Automatically restructure the interconnection among related IoT device nodes during the deployment process.

### 15.2 Thing App

As mentioned above, patentee's prior applications include an IoT App Store and Ecosystem.

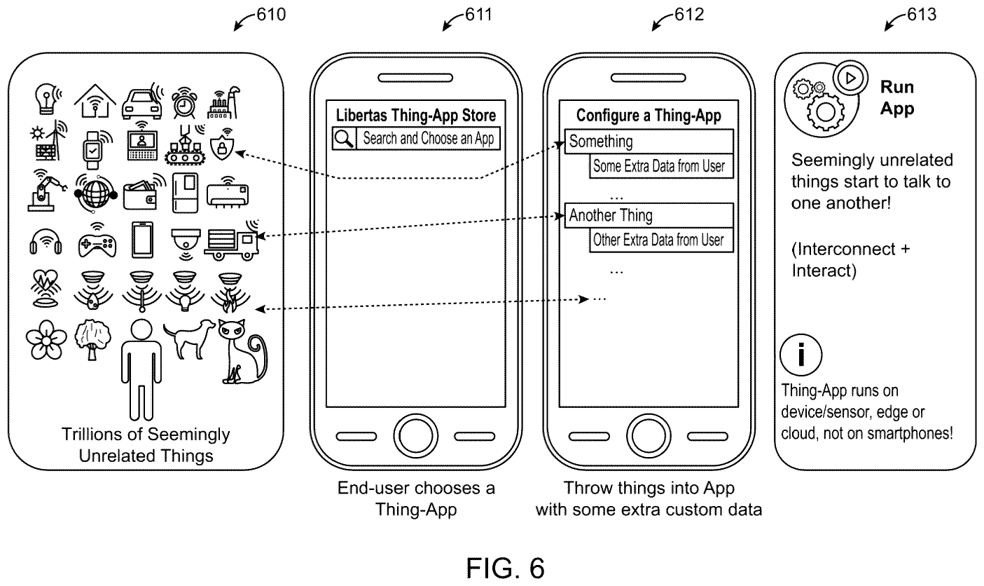

For purposes of the present patent, a term called “Thing-App” is introduced, which is augmented with interconnection meta-data. At a high-level, a Thing-App can be viewed, in conjunction with FIG. 6, as working as follows:
1. Viewed most broadly, outline 610 of FIG. 1 represents the eventual possibility of trillions of IoT “things” (or devices) deployed worldwide. In their initial state, such IoT things can default to having no interconnectivity with each other. Only a small subset of IoT devices is available to any particular end-user, which we can refer to as the end-user's Device Set.
2. As discussed above, the Prior Applications include an IoT App Store (or what may also be called a Thing-App Store). An example interface, by which an end-user can select a Thing-App from the Thing-App store, is depicted as available to an end-user through a Smartphone interface 611 (see FIG. 6). An end-user can use the interface to choose a Thing-App for deployment on his or her Device Set.
3. Once a Thing-App is selected, Smartphone interface 612 represents an end-user accomplishing at least two types of configuration:
   a. From the end-user's Device Set, choosing the particular IoT things for execution of the chosen Thing-App (the chosen IoT Things). Such selection can be referred to as “throwing” the selected things into the chosen Thing-App.
   b. Using the Data Editor to configure (in accordance with the developer's meta-data) the behavior of the selected things under the chosen Thing-App. Such end-user configuration data is referred to as “Extra Data from User” in Smartphone interface 612. In general, this can be referred to as an App configuration process.
4. Smartphone interface 613 represents the end-user starting the Thing-App to run. Unknown to the end-user, and in accordance with deployment meta-data from the developer, execution of the chosen Thing-App is deployed to the chosen IoT Things. Prior to the deployment invention, each IoT device, of the end-user's Device Set, may have been unrelated to each other IoT device of the Device Set. At most, their interconnection would be through the IoT controller or hub (as described in the Prior Applications). However, with the present invention, these seemingly unrelated IoT things (or devices) begin to communicate with each other—without such messaging needing to pass through the IoT hub. The chosen IoT Things represent their own autonomous network (or set of interconnections) that has advantages, relative to the hub, similar to those of the hub relative to the cloud:
   a. Lower latency, between sensing a condition and acting in response.
   b. Continued operation of IoT apps despite a greatly degraded (or lost) network connection with the hub.
   c. Continued operation of IoT apps despite a loss of operation by the hub.
   d. Opportunities for enhanced end-user privacy.

The implementation requires the end-user to input data (called a data instance) with a tree structure. The application developer defines the tree data's structure (by creating a schema or metadata).

Mostly, the Thing-App is not running on Smartphones. Rather, as discussed above, it can run on the relatively tiny computer system provided to IoT devices. More specifically, the on-board computer system typically provided to an IoT device is called a Micro-Controller Unit (MCU). More generally, the deployment procedure, executed by an IoT hub, will automatically pick the best node type on which to run the Thing-App. (While it may be an IoT device, depending on the circumstances, it may also be the hub, or an edge or cloud server may be selected.) The net result for the developer is an ability to “write once, run everywhere,” on any of the billions of MCU chips resident within billions of IoT devices.

The decentralized approach of the present invention means an IoT that centers much more around the end-user, instead of where the end-user's App's are executed. No other solution is known to offer applications running on essentially any node (or IoT device) within a distributed IoT network. Solutions prior to the Prior Applications rely on a “centralized” location for interconnection and interaction, such as a cloud or an edge device.

Further, the present invention offers an “ad-hoc” and user-centric approach to IoT network design. Guided by the developer's meta-data, the invention can dynamically restructure and optimize interaction among nodes within an IoT network when an end-user deploys a new App instance or removes an existing App instance. By optimizing interaction, new interconnections among related “things” may be automatically established.

There are many advantages to an “ad-hoc” user-centric approach, including greater security, greater privacy, better reliability, lower latency, longer battery life, and more efficient network bandwidth utilization.

15.3 why does Interconnectivity Matter?

For IoT systems centered around the cloud or edge, all devices and sensors can connect to the central node. The central controller has enough RAM and storage space to maintain the connectivity.

Each IoT device may only be provided with a relatively tiny MCU that, under current conditions, may only offer a few dozen KB of RAM and usable flash storage. Such resources are only sufficient to maintain highly limited connectivity.

Even for a centralized network, the MCU should still be capable of maintaining access control, for security and privacy reasons. As long as access controls exist, it should still be possible to have end-to-end encryption between any two nodes (or IoT devices) with access to one another.

Despite the hardware providing the capability, the entire IoT industry still largely ignores access control, and particularly end-to-end encryption.

Even with end-to-end encryption ignored, there is still need for an MCU-equipped IoT device to maintain a list of the other devices to which it should be connected.

This kind of “logical linking relationship” is called “binding” in networks such as Zigbee or Thread. In this document, “binding” and “interconnectivity” are used interchangeably. As a simple practical example, an end-user may wish to have a light switch bound to three lights. In this way, when the switch is turned on, the “on signal” will be sent to all three bound devices automatically.

Another example is a battery powered sensor that only “wakes up” periodically, to prolong battery life. When the sensor decides it should send out an updated reading, it may be configured to push the message to a set of predefined peer devices.

Without binding, a device may have to broadcast its every message to every other node. Each other node is left with the responsibility for “filtering out” messages not targeted to itself. As a network grows to include more and more nodes, it can be appreciated how the number of useless messages grows to consume all available bandwidth.

### 15.4 Node and Endpoints

A node is a physical IoT device or sensor in an IoT network.

A node may represent more than one endpoint, in which case each endpoint represents a logical device. For example, a single wall switch may be able to control two lights separately. Therefore, each light is an endpoint.

### 15.4.1 Load and Non-Load Endpoints

Every endpoint for the present invention is either a load or non-load endpoint.

A load endpoint is a “real” device, where the following are some examples:
1. The device is a controller, such as one that allows a light bulb to consume electrical power and provide illumination; or
2. The device is a sensor device that provides readings to other endpoints.

A non-load endpoint is a device that interacts with load endpoints, where the following are some examples:
1. An IoT device that sends control signals to a load endpoint, such as a remote-control button; or
2. The device is an endpoint that receives data from a load endpoint, such as state change information or other sensor readings.

### 15.4.2 LibertasDevice

In the inventive App programming presented herein, “LibertasDevice” refers to a data type that represents an endpoint, but is not a physical device.

Throughout this patent, a “LibertasDevice node” refers to a node representing a device endpoint in the end-user-created input data, which is the App process startup data (entry function arguments) and usually a list of tree data.

### 15.5 Binding

Binding is to establish access between two endpoints on IoT nodes. Each binding is defined as a one-way relationship. Between one endpoint (e.g., a first endpoint) and another (e.g., a second endpoint), the first endpoint may have an incoming binding, an outgoing binding, or both.

Binding defines access. It also defines data flow. For example, if the state of an endpoint changes, it sends a state-update message to every endpoint in its “outgoing” binding table.

The basic concept of binding is known. Binding was defined, for example, in the Zigbee (see Zigbee Alliance) and Matter (see Connectivity Standards Alliance) protocols. In practice, binding is usually further constrained. For example, binding may be limited to a set of capabilities (called “clusters” in Zigbee and Matter).

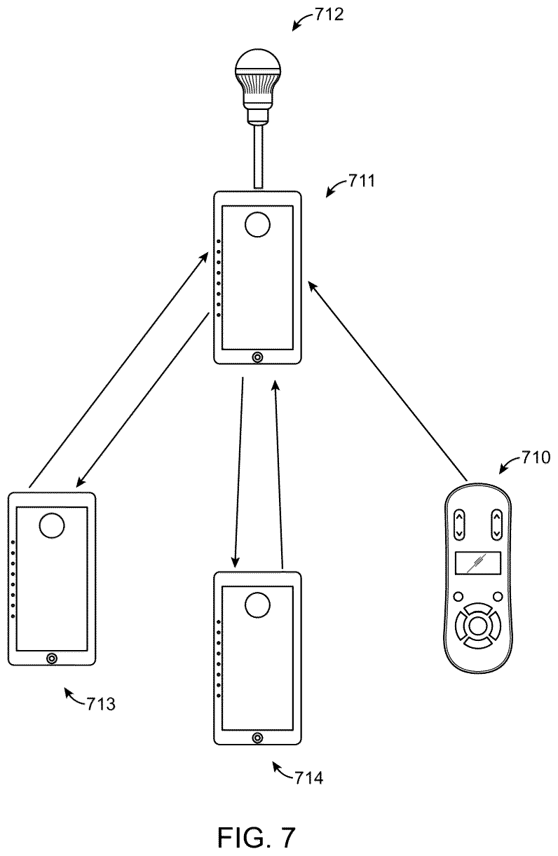

FIG. 7 presents a simple example by which binding can be explained. It is a multi-way light setup with a remote (labeled 710). A “real” light switch 711 has a light bulb 712 as its load. The other two switches (713 and 714) can remotely control the “load switch” 711 from different locations. A remote control 710 can also be used to control the light.

Note: between each remote switch (713 or 714) and the “load switch” (711), there are two bindings: a first going from remote switch to load switch, and a second from load switch to remote switch. The second binding is needed because the remote light switch also has a load of its own: LEDs that can indicate the status of the load. So, every time the status of the load switch (i.e., 711) changes (e.g., from on to off), it sends a status update message to the remote switches (i.e., 713 and 714) to which it is bound.

The remote control 710 does not need a second binding because it was designed to not have a load of its own (to which a message from load switch 711 is sent). This is because the remote chosen is battery powered, and it is desired to keep the remote powered for as long as possible. The remote 710 only has a first binding, from the remote to the load switch 711, via which a message is sent when the end-user presses a button. To conserve the battery, the remote does not receive an update when the status of load switch 711 changes. So, FIG. 7 shows only a one-way binding (outgoing from remote 710 and incoming to the load switch 711).

### 15.5.1 Simple and App Binding

The binding in the example above, in the Libertas system, is called simple binding. Simple binding binds several non-load endpoints to a single load endpoint.

In Libertas, there is a restriction on simple bindings: A non-load endpoint can only bind to at most one load endpoint. In other words, a non-load endpoint cannot bind to two or more load endpoints. This restriction can be lifted. If lifted, a single switch endpoint can be bound (for example) to multiple IoT light device endpoints. The switch will work unambiguously, to send control signals, but interpreting the feedback from multiple IoT light devices cannot be simply interpreted.

Another type of binding, called App binding, is between an App (as executing on an IoT device) and other types of endpoints. (Unless context specifically indicates otherwise, the use of the term App herein should be regarded as another term for Thing-App.)

In general, App bindings have no restrictions.

Within a single IoT device, despite the limited resources of an MCU, there can be more than one App running simultaneously. Each App may be assigned a unique endpoint, or they can share a single endpoint. Either approach can be used, without much difference in terms of design and implementation. Herein, for purposes of example, we choose the single shared endpoint (across the multiple Apps of an MCU) approach.

With multiple Thing-Apps sharing the same endpoint, more than one Thing-App may need to access the same device. A software component called the “Thing-App engine” ensures an IoT device's data is properly updated across all interested Apps. The updating is accomplished through a Thing-App API (or Application Programming Interface).

### 15.5.2 Internal Binding

Bindings can be established among multiple endpoints within a single physical device. For example, multiple buttons on a switch can be bound to a single dimmable light on the same device. Each button may be used to control a different dimmer level. For App bindings, the App endpoint could be different than the device endpoint, even if both endpoints are on the same device.

From a data exchange perspective, internal binding is no different than external binding. Nevertheless, internal binding is (in general) more reliable than external binding.

### 15.5.3 Read/Write Device Access and Binding Direction

Every Libertas IoT device (also referred to as a “LibertasDevice”) node can specify an explicit access flag. There are two relevant access flags: “Read” and “Write.” The access flag serves as both access control and binding direction that affects the automatic data flow.

The Read flag only allows an incoming binding from the Libertas IoT device node.

The Write flag only allows outgoing binding to the Libertas IoT device node.

In Libertas meta-data (or schema), access is specified as a “LibertasFieldAccess” attribute on a meta-data node of the LibertasDevice type.

15.5.4 Unicast Vs. Multicast

An endpoint sends data to each of its bound endpoints. There are two main ways to send data: unicast and multicast.

Unicast sends a message to one recipient endpoint, while multicast sends one message to a group of recipient endpoints.

Multicast is defined as a “group endpoint.” A group endpoint is defined with a group address plus endpoint.

Sending a few unicast packets is more efficient if only a few bound endpoints exist. However, if there are more bound endpoints than a certain “threshold”, it is more efficient to use multicast. Therefore, we define the threshold as the “multicast threshold.”

### 15.5.5 Proxy

A device may act as a “proxy” for another device. Usually, the “proxied device” is a battery powered device, and the proxy device is a full-powered device. To save battery life, the proxy provides the network-level and full application functionality on behalf of the battery powered device.

In practice, a binding to a battery powered device may result in an actual binding to its proxy device. For simplicity, in this document we will still focus on the “logical” binding relations among devices and let the underlying network infrastructure handle such details as use of a proxy.

### 15.6 Central Controller, Hub, and Gateway

In an IoT network as originally envisioned, essentially every node can be a controller. However, end-users generally prefer dealing with one central controller, for such reasons as convenience.

The central controller, as presented here, is a particular node owned by the system owner. It is the node that has maximum permissible access to other nodes. It is also the node to which other nodes grant maximum possible trust, including all end-users.

From a security perspective, the central controller can also be called the “trust center.” The Zigbee security model uses this terminology.

In general, a central controller acts as the primary manager of the private IoT network of the network owner. Example tasks include: adding new nodes to a network, removing an existing node from a network, and configuring nodes. In addition, through the central controller, the network owner can configure bindings and Apps.

As used herein, a “hub” is a local node connecting to every device to which the end-user has access.

A gateway is a node that bridges more than one network. The networks may have different communication protocols and different wireless technologies. As a result, the different networks may not be able to communicate directly without the gateway.

More importantly, a gateway can work as a bridge between a private IoT network and the Internet in general.

As used herein, a hub can also act as a gateway, between every device on a private IoT network and the Internet.

Usually, the central controller also functions as a hub.

### 15.7 Data Security

Bindings do not only define logical relations and data flow among devices. They can also cause changes to the non-volatile configuration of related devices and the network.

First of all, since bound devices automatically talk to one-another, the binding operation needs to include satisfactory compliance with security requirements, such as:
1. Ensuring the user, who causes the binding operation, has proper access to all the related devices. Since the client tool cannot be fully trusted either, the check should be performed again in the backend central controller once the request is received.
2. Each IoT device is not to be fully trusted either. As a security best practice, a separate shared key should be established. The key can be shared between two unicast parties or with a group of multicast parties. If there is a unique key and some anti-reply mechanism (for example, counter mode encryption), we can assume a correctly decrypted message is both authenticated and authorized.

### 15.8 Network Configuration

As for the network configuration, binding may be established among devices within the same network using the same network protocol, or it can be cross-network with different protocols. If a binding happens to be cross-network, an appropriate routing strategy can be used (such as TCP/IP), on a gateway, to ensure the traffic can reach cross-network. The actual traffic can be sent via the gateway, and the unique identification of the destination can be included in the message or (if necessary) inferred from the message itself. If different protocols are involved, when crossing between networks, a protocol translation node or layer can be deployed.

### 15.9 Non-Volatile Memory

Many of the changes to a network or its nodes can be stored in the non-volatile memory of related devices and network nodes. The object of such changes can include: a binding list, encryption keys, or access control list.

If a binding is cross network, additional information about the binding can be kept in the non-volatile memory of a gateway, to ensure messages are delivered properly. Some examples of such additional information include: routing information, an identification map, and protocol translation information.

### 15.10 Thing-App Developer and End-User

Thing-App developers write App code and share the App with end-users.

An end-user causes execution of the App by creating an App process, instance, or task.

Usually, while creating an App instance, the end-user provides additional data that acts to setup the startup configuration. Such configuration data usually includes one or more tree structures. The App developer designs the higher-level template or pattern of the tree structure (referred to above as meta-data or schema).

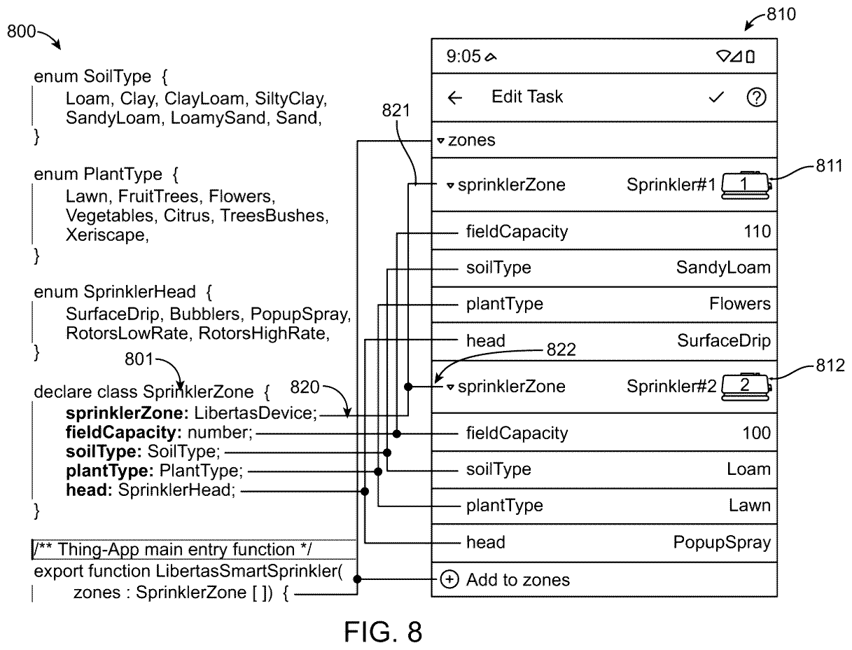

FIG. 8 (the left side, 800) depicts part of the code for a sprinkler scheduler App. In the code shown, the structures, that organize data entered by end-user, are defined. The definition of the structures is usually called “data schema” or “meta-data.” Note that the schema is also a set of tree structures.

The right side (810) of FIG. 8 depicts an (example) automatically-generated user interface (or UI) on an end user's Smartphone. As shown, the UI already includes data input by the end-user. The end-user UI is automatically generated and optimized based on the schema (shown on the left side of FIG. 8). In many cases, schema can be automatically generated by analyzing an App's source code with a developer's tool.

Connections, between an example declaration of data (left side, FIG. 8) and an instance of actual end-user user data (right side, FIG. 8), are included in the diagram. For example, the left side depicts a declaration 801 of a “SprinklerZone,” which is comprised of five items of data: sprinklerZone, fieldCapacity, soilType, plantType, and head. The right side shows a UI of two sprinklerZones: zone 1 (at 811) and zone 2 (at 812). The connection for zones is shown by line 820 emerging from sprinklerZone on the left, which then divides for each of zone 1 (line 821) and zone 2 (line 822).

As can be seen, each node (of end-user-created data) can be either an IoT device (e.g., a “LibertasDevice”) node, or one of several other data types (e.g., “number,” or “SoilType”). Note that a LibertasDevice node may be located anywhere in a data tree, depending on the application requirement.

### 15.11 Meta-Data and Node Attributes

A developer may add a variety of additional attributes to a meta-data (or schema) node. An attribute may be related to a feature in the front-end UI, a back-end transaction, or both.

Depending on the nature of the actual programming language used to develop the Thing-App, the node attributes can be specified in source code as design-time attributes or through a GUI based meta-data editor. For an example meta-data editor, see Prior Applications, Section 5 (“Meta-Data Editing or Extraction”). With the use of TypeScript as the programming language, views can be presented: of source code attributes, from a meta-data editor, or both.

Note: official TypeScript does not support design-time attributes. Patentee's meta-data editor is a more robust solution and will work with many programming languages.

### 15.12 Deployment Target

A Thing-App can almost always run inside a hub because:
1. A hub usually has more CPU and memory resources than IoT devices or sensors with a small MCU.
2. A hub, by default, has access (bindings) to all nodes in the IoT network.

In many cases, however, it is more optimal to run an App inside an IoT device rather than the hub.

Part of the present invention is permitting the developer to explicitly instruct, in the meta-data, that an App run on an IoT device node (e.g., a LibertasDevice node), or on a set of IoT device nodes. In general, developers know best the nature of the App he or she has created, the resource requirements of the App, and the App's execution pattern (e.g., power consumption, bandwidth utilization, or both).

Permitting the developer to constrain the execution environment of his or her App is an important part of achieving the design goal of “write once, run everywhere” across billions of devices with different kinds of CPU's or MCU's.

### 15.12.1 Qualified Node

For a particular Thing-App, not every IoT device node type is “qualified” to run it. For example, a node may have no capability of running Apps at all, or the node may not have enough resources to run a particular App. (Types of resources that may be insufficient include CPU capacity, storage, or bandwidth budget.) Capability requirements can be added as attributes to the meta-data. For the sake of simplicity, in this patent we assume the central controller already knows how to identify qualified nodes based on their capabilities.

### 15.12.2 DeploymentPolicy Attribute

If a developer chooses a type of IoT device node as a deployment target, the “DeploymentPolicy” attribute can be specified on its corresponding meta-data node. There are four kinds of deployment targets:
Any—Any qualified node is a deployment candidate. Only one node is required to deploy the application. Note: if no node is qualified, the hub can be used.
All—The App should be deployed on all qualified nodes. Note: the node should be within an array (though not necessarily an immediate member of the array). If a node is not qualified to run the App, all such “nodes” can be deployed to the hub.
ForceAny—Similar to “Any.” The difference is that the deployment fails if no qualified LibertasDevice node exists.
ForceAll—Similar to “All.” The difference is that the deployment fails if any node is not qualified.

The Deployment Policy attribute is truly orthogonal to those permitted for entry in the “Meta-Data Editing” or “Argument Editor” of patentee's prior applications.

15.13 Binding from App Deployment to Devices

Deployment of an App may involve one or more LibertasDevice nodes from the end-user's input data. If the node is not a Hub, the deployment will involve one or more App endpoint(s) inside the related device nodes. In Libertas, a single device can run more than one Thing-App instance, but the device only exposes one “App Endpoint,” and that endpoint is shared among all running Thing-App instances.

Nothing likely needs to be changed if the App is deployed to run on a hub, rather than IoT devices, because the hub already has bindings to all the related nodes' endpoints.

However, if an App is deployed to an actual LibertasDevice node (with “Any” or “All” deployment target settings), the bindings among related endpoints may not exist beforehand.

### 15.14 Massive Deployment

Developers may instruct the platform to deploy the same App instance to more than one device node provided by the end-user.

The deployment target of “All” or “ForceAll” are used to specify massive deployment.

Massive deployment is used to deploy Apps to many nodes with some shared dependencies (such as shared bound devices and configurations), while each node may have its own dependency.

Massive deployment offers a better end-user experience by improving efficiency in deployment and management.

### 15.14.1 Binding for Massive Deployment

If the App can only be deployed to at most one IoT device (e.g., a LibertasDevice), there is a high probability the deployed LibertasDevice will want to communicate with other LibertasDevices in a same or similar configuration. After all, if the App is not to access other devices, why would the developer or end-user include those devices in the configuration?

Nevertheless, for massive deployment, each deployed LibertasDevice may only need access to a subset of the LibertasDevices in the configuration. Another type of attribute, on a LibertasDevice meta-data node, can be used to “remove” binding, to a certain subset of LibertasDevices, from a particular deployed node.

### 15.14.2 DeployRemoveDependencies

Libertas meta-data is a schema of tree data, just like the schema for XML (see World Wide Web Consortium, or W3C) and JSON (see the Open JS Foundation).

The part of the tree-data instance based on the schema can be represented as a simple search path, just like an XML path (or XPath). In fact, a list of XPaths can be used to represent the nodes to be excluded from the binding list of the current LibertasDevice data node.

“DeployRemoveDependencies” is an attribute, on a LibertasDevice metadata node, to remove bindings by the list of paths specified as the attribute's value. Each path follows the specification of XPath, with the following differences.
1. Because most likely a path specification is used to remove the binding to sibling nodes in an array, including the siblings of the nearest parent array, one can use the “sibling::” prefix to represent both the “following-sibling::” and “preceding-sibling::” prefix.
2. If there is no “sibling::” prefix in the path, one can assume the first path, after any “ . . . ” parent path, is for the sibling path.

Note: this attribute can be used to inform the central controller to “trim off” affected nodes from the user input tree data. The trimmed off nodes may be of any type, not limited to LibertasDevice nodes. In a massive deployment setting, each deployment target node may only see a subset of the user input data.

With the support of “DeployRemoveDependencies,” if the end-user later modifies some input data that is only related to a single deployed device, the central controller will only update the App user data of the affected device while the other device will keep running unaffected.

### 15.14.3 Hub Split Deployment

In a massive deployment, some target devices for potential deployment may not be qualified devices. In other words, there may be devices that cannot run the App. In this case, the App needs to be deployed to a hub to remotely talk to the unqualified devices.

Note: the “DeployRemoveDependencies” attribute can be used to ensure the hub only sees the data related to the unqualified devices. In other words, any path that matches “DeployRemoveDependencies” with a qualified deployment device will be removed from hub deployment data.

### 15.15 An Example

The example is an algorithm to control actuators based on sensors and some configuration data.

There is one Global_Sensor and Global_Config that is shared by all actuators.

Also, there may be many Local_Sensors shared by a relatively smaller group of actuators. Each Local_Sensor comes with a Local_Config.

Each actuator comes with an Actuator_Config.

This app is an example of massive deployment.

The goal is to run the App inside every Actuator. The App code controls the Actuator based on data from sensors to which the Actuator is linked, along with corresponding config data. A Global_Sensor and Local_Sensor are linked to the Actuator.

### 15.15.1 the Code

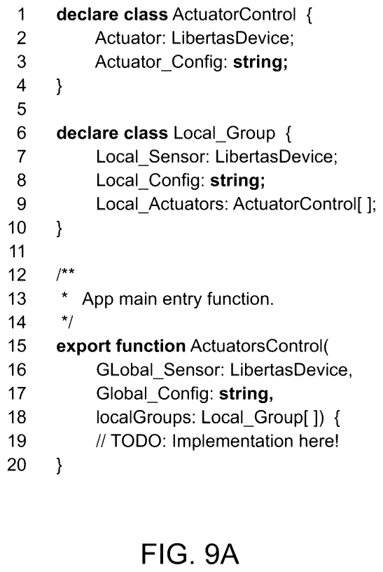

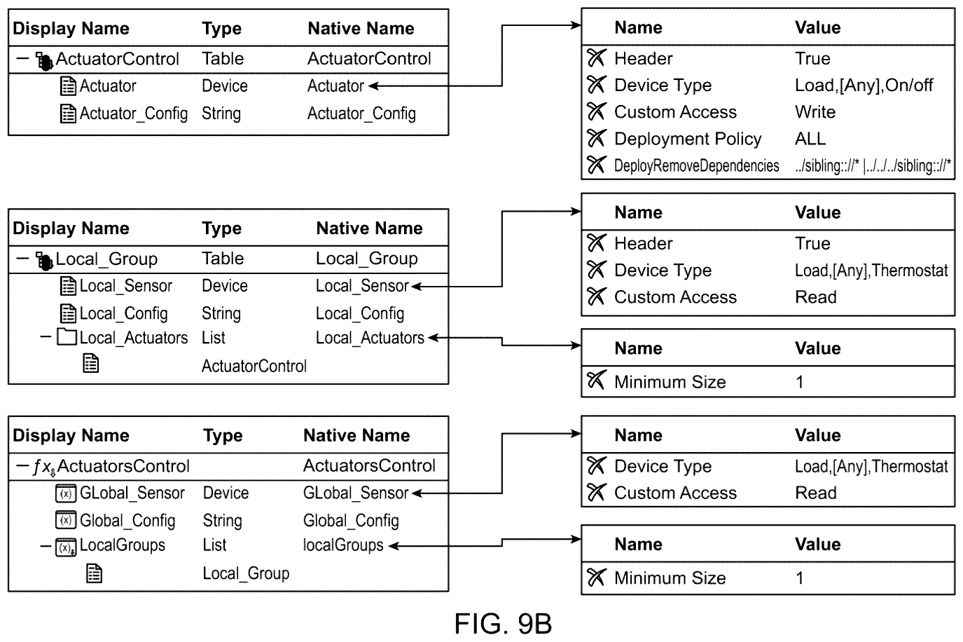

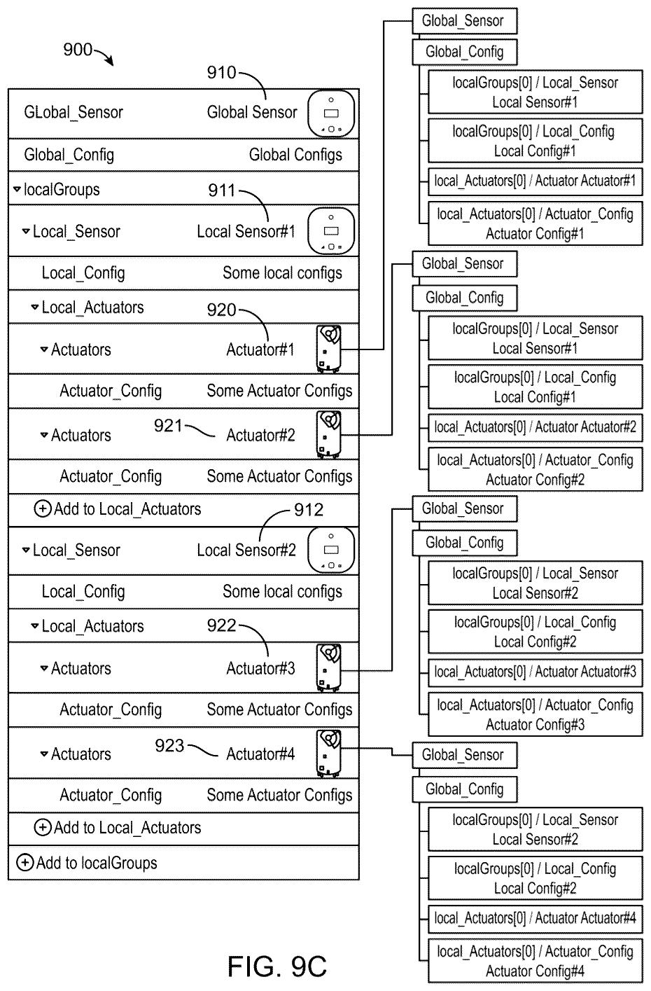

FIG. 9A depicts the definition part of the code. It shows the declaration of two classes (at lines 1 and 6) and the declaration of the App entry function (at line 15). Note: there are type cross-references in the class declarations and the function declaration.

FIG. 9B depicts the attributes associated with some fields in some nodes of class members and entry function arguments. In this example we focus on the “DeploymentPolicy” and “DeployRemoveDependencies” attributes, as well as the “Custom Access” attributes, of meta-data nodes of LibertasDevice type.

### 15.15.2 the User Input Data

FIG. 9C shows (on the left) a screenshot (900) of user input configuration data on an end-user's smartphone. Clearly, that end-user chose one global sensor (910), two local sensors (911 and 912) and four actuators (920-923).

Since the developer intends to deploy the App to every actuator, and the developer has already defined the “DeployRemoveDependencies” attribute with two search paths, some user input data will be removed for each actuator node during deployment.

On the right side of FIG. 9C is the actual user input data each actuator node sees.

In this example, if the end-user later modified the local config data of a single actuator, only the input data of that actuator is modified. So, the central controller will only update the App user data of the affected actuator while other actuators will keep running unaffected.

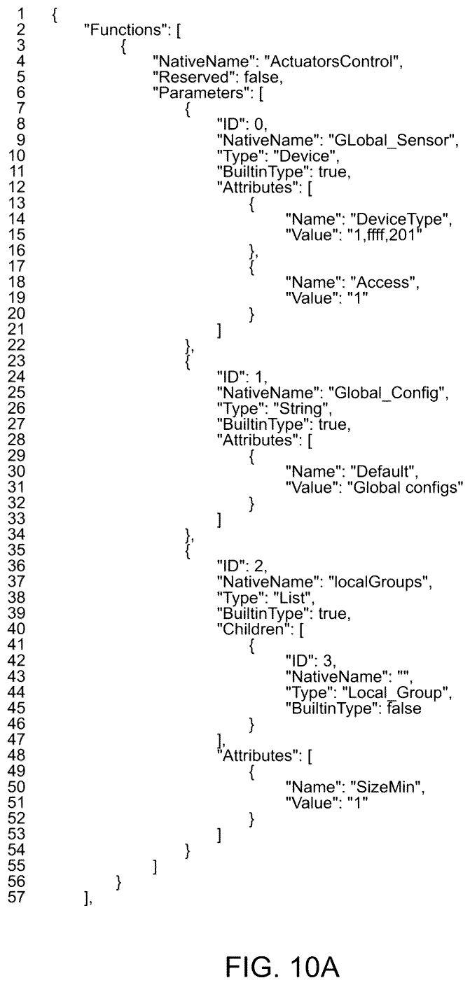

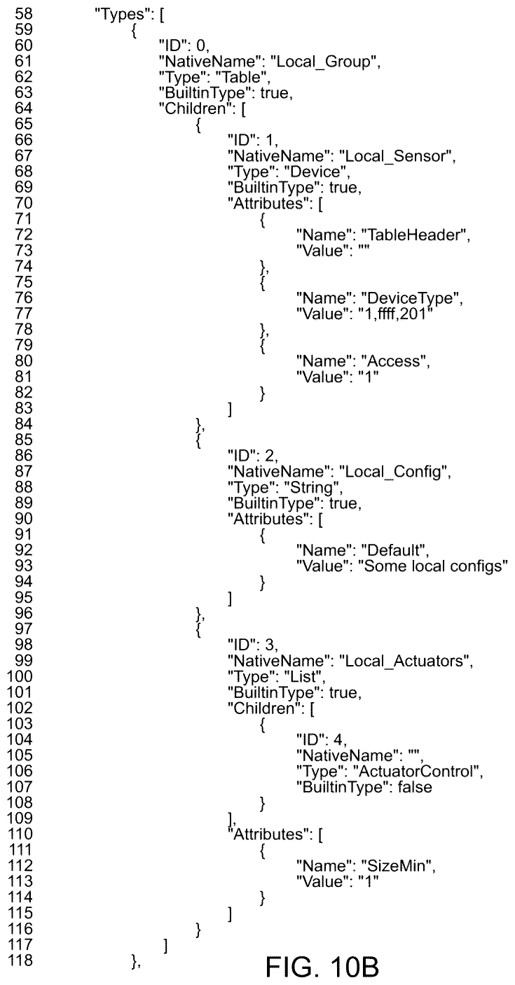

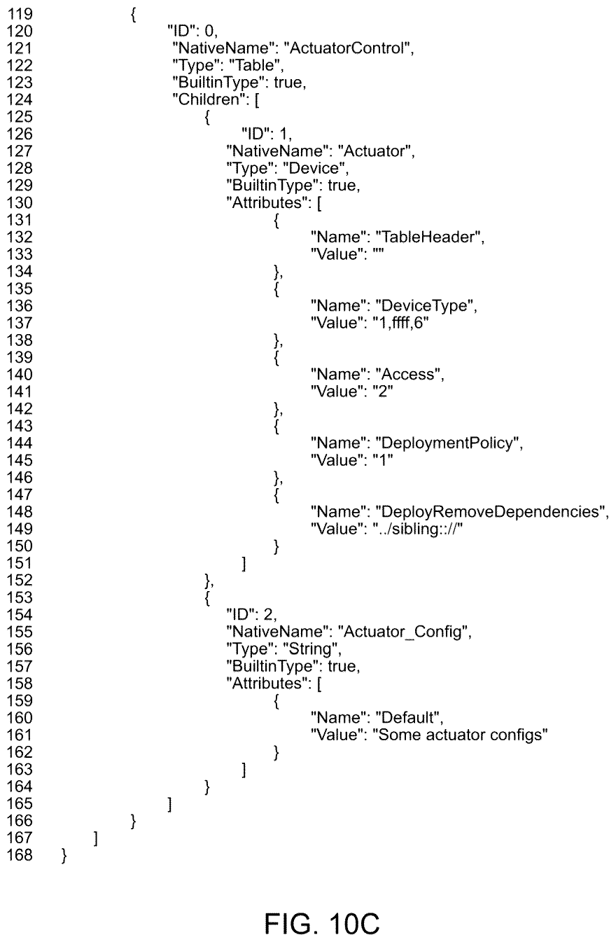

FIGS. 10A-10C depict the internal representation of the metadata in JSON format.

### 15.16 App Binding

App binding happens when an App is deployed to one or more qualified LibertasDevice nodes. The central controller automatically binds the App endpoint, on a deployment target device, with other dependent endpoints.

### 15.17 Further Optimization

On a given device, if multiple endpoints are bound to one remote endpoint, we can further optimize the binding by removing the duplicates so that there is only one incoming binding. Any update can be sent to all endpoints internally. In most cases, duplicate outgoing bindings can also be removed if it makes no difference from where the control signal comes. Whether or not this kind of optimization is implemented does not significantly change the algorithms presented herein.

### 15.18 Additional Information

### 15.18.1 IoT Device

As used herein, an IoT device is a physical device that, through the provision of an embedded computer system and network connectivity, becomes remotely accessible. The remote access can be for purposes of instructing the physical device (remote control), acquiring information from the physical device (remote sensing), or both.

The power of such IoT devices has typically arisen from their ability to interoperate with each other, in new and often unforeseen ways, under the direction of a remotely-located general-purpose computing platform (the “IoT controller”). By adding new software to the IoT controller, a new behavior can emerge, from the IoT devices with which it is connected. For example, such interoperability can often be characterized as remote sensing, from one or more IoT devices, causing, under the direction of an IoT controller, changes in the remote control of one or more IoT devices.

While possessing network connectivity, an IoT device does not need to include the capability of connecting to the Internet on its own. For example, it is often the case that the end result to be achieved, by software executing on an IoT controller, can be accomplished with IoT devices that are all located at a common deployment location. For at least this reason, it is often the case that the IoT device itself only possesses LAN connectivity. If the IoT controller is also located at the deployment location, it can be the case that an entire IoT system is created which lacks Internet connectivity. However, it is almost always the case that an IoT system includes, at some part of the system, at least one Internet connection.

While an IoT device can achieve its network connection using non-IoT LAN networking protocols, such as Ethernet or the 802.11 suite of protocols, in the context of an IoT device, such LAN protocols often involve significant disadvantages. For example, a non-IoT LAN protocol can possess any combination of the following disadvantages:
require hardware that consumes an excessive amount of power;
require hardware too expensive for incorporation into the device in an economically-viable way;
provide connectivity with an unacceptably low level of reliability;
is not designed to accommodate a sufficient number of devices with simultaneous network connectivity.

For these reasons, and others, the LAN to which an IoT device connects is often specialized to the needs of IoT-type systems. Such IoT-LAN protocols typically possess at least some combination of the following advantages:
low-power;
inexpensive hardware;
high reliability;
accommodate a large number of simultaneously-connected devices.

In order to achieve these advantages an IoT-LAN protocol can often leverage certain requirements that are easier to achieve than those for which non-IoT LAN's were designed. These advantages can include, at least, any combination of the following:
low-speed connectivity;
small message size.

Example IoT LAN protocols based on wireless connectivity include the following:
6LoPAN (RFC 4944, and related, of the Internet Engineering Task Force, Freemont, CA, USA),
Bluetooth (Bluetooth Special Interest Group, Kirkland, WA, USA).
ZigBee (ZigBee Alliance, Davis, CA, USA), and
Z-Wave (Z-Wave Alliance, Freemont, CA, USA).

An example IoT LAN protocol that uses both wired (powerline wiring) and wireless connectivity is Insteon (SmartLabs, Inc., Irvine, CA, USA).

An example of a particularly common IoT device is an IoT device that replaces the ordinary wall-mounted light switch. In contrast to the ordinary wall switch, which simply opens or closes an electrical circuit as a result of mechanical user input, the IoT wall switch has the following two capabilities:
It becomes a remote sensing device. Specifically, the remotely-located IoT controller can detect whether the switch is in the “on” or “off” position, or receive the on/off state change notification in real time.
It becomes a remote controlled device. Specifically, the remotely-located IoT controller can instruct the wall switch, to either open or close the electrical circuit to which it is connected.

For purposes of backwards compatibility, and to provide protection against temporary interruptions in an IoT-based service, it is often the case that an IoT device will offer a level of local control. For example, for an IoT wall switch, setting its switch to the “on” position will typically cause completion of the electrical circuit to which it is connected, without the involvement of an IoT controller. However, such local control is typically implemented as simply an additional, and parallel, control path. For example, even if the light, electrically powered by an IoT wall switch, has been turned “on” as a result of its switch being put in the “on” position, subsequent signals from the IoT controller can still toggle the light between “on” and “off” states.

In certain circumstances, an IoT “device” can be simulated, within the context of a more general-purpose computing system. For example, many smartphones qualify as a general-purpose computing system, and are often used as such. However, the smartphone's combination of a small physical package, along with a rich variety of input/output devices, permit it to be used, for at least certain limited periods of time, as a simulated special-purpose device.

For example, by executing an appropriate app, a smartphone can act as if it is an IoT “switch.” Under such circumstances, for example, successive tappings, on a “button” on the smartphone's screen, can be sensed, by software executing on an IoT controller, as the opening or closing of a switch.

### 15.18.2 Computing Equipment

In accordance with what is ordinarily known by those in the art, an IoT Controller can be implemented through the use of any suitable computing hardware. Suitable hardware can include the use of one or more general purpose computers or processors.

The Application Store can be implemented as a web server. As is known by those in the art, a web server can be implemented through the use of any suitable computing hardware. Suitable hardware can include the use of one or more general purpose computers or processors. Such processors or computers can be dedicated, or, as has become popular in more recent years, their use can be leased through a variety of “cloud computing” service providers.

Each end-user or developer can interact, with a Controller or Application Store, from a web-based interface executing upon a suitable client computer. Suitable hardware for a client computer (including a Smartphone) can include the use of one or more general purpose computers or processors.

Hardware implementation techniques can include the use of various types of integrated circuits, programmable memories (volatile and non-volatile), or both.

Computational hardware, whether in integrated circuit form or otherwise, is typically based upon the use of transistors (field effect, bipolar, or both), although other types of components (e.g., optical, microelectromechanical, or magnetic) may be included. Any computational hardware has the property that it will consume energy, as a necessary part of being able to perform its function. Also, regardless of how quickly it can be made to operate, computational hardware will require some amount of time to change state. Because of its basis on physical devices (electronic or otherwise), computational hardware, however small, will occupy some amount of physical space.

Programmable memories are also often implemented in integrated circuit form, and are subject to the same physical limitations described above for computational hardware. A programmable memory is intended to include devices that use any kind of physics-based effects or properties, in order to store information in at least a nontransitory way, and for an amount of time commensurate with the application. The types of physical effects used to implement such storage, include, but are not limited to: maintenance of a particular state through a feedback signal, charge storage, changes to optical properties of a material, magnetic changes, or chemical changes (reversible or irreversible).

Unless specifically indicated otherwise, the terms computational hardware, programmable memory, computer-readable media, system, and sub-system, do not include persons, or the mental steps a person may undertake.

For any method, procedure or technique described above, to the extent it is implemented as the programming of a computer or other data processing system, it can also be described as a computer program product. A computer program product can be embodied on any suitable computer-readable medium or programmable memory.

The kind of information described herein (such as data and/or instructions), that is on computer-readable media and/or programmable memories, can be stored on computer-readable code devices embodied therein. A computer-readable code device can represent that portion of a memory in which a defined unit of information (such as a bit) can be stored, from which a defined unit of information can be retrieved, or both.

### 15.19 Glossary of Selected Terms

application or App: Unless the context specifically indicates otherwise, used herein to refer to an item of application software, written by a developer for use by an end-user.
Device Set: The small subset of IoT devices available to any particular end-user.
end-user: An entity acting in the role of actually using an application. Can be the same entity as the developer.
entity: As used with respect to the definition of “end-user” and “developer,” can be an individual person, a group of persons, or an organization (e.g., a corporation, company, or association).
developer: The entity responsible for the computer programming resulting in the creation of an application.
GUI: Graphical User Interface.
IoT: internet-of-things.
IoT device: see “Additional Information” section.
task: An instance of an end-user-selected IoT application (or App) that is actually executing upon an IoT Controller, hub, or device.
UI: User-interface.

While the invention has been described in conjunction with specific embodiments, it is evident that many alternatives, modifications and variations will be apparent in light of the foregoing description. Accordingly, the invention is intended to embrace all such alternatives, modifications and variations as fall within the spirit and scope of the appended claims and equivalents.

1. A method for automatically deploying and running any number of independent instances of an application within an IoT network, comprising:
receiving an application created by a developer;
receiving the application meta data, as created by a developer, for the automatic deployment of the application;
receiving the application including, in the meta data, a deployment policy;
using the meta data to automatically generate a GUI by which an end-user builds a data tree configured for a specific IoT network;
presenting, to an IoT controller, the application and the data tree;
traversing the data tree, find the minimum partition for each qualified physical device;
using the found minimum partitions, the IoT controller does steps comprising the following for each qualified physical device:
loading an instance of the application;
giving the application instance that minimum partition containing the peer logical devices to which it needs to connect; and
connecting the application instance to its peer logical devices.

2. The method of claim 1 further comprising:
automatically finding for each qualified physical device the minimum partition needed to run the application instance on the qualified physical device.

3. The method of claim 2 further comprising:
deploying, based on deployment attributes, an application instance to all qualified physical devices, just to any single qualified physical device or to no qualified physical device.

4. The method of claim 3 further comprising:
having a physical device with a CPU and a local logical device;
having a field for each logical device, through the application meta data, called Deployment Policy;
skipping deployment of an instance of the application, if the Deployment Policy is not set, including skipping the deployment of an instance of the application on the physical device that hosts the logical device;
determining on which physical devices the application will run, wherein Deployment Policy choices include ALL or ANY and the determining steps comprise:
finding, for a first set of logical devices having a Deployment Policy of ALL, a first set of qualified physical devices that can each host the first set of logical devices, and deploying the application on each member of the first set of qualified physical devices;
finding, for a second set of logical devices having a Deployment Policy of ANY, a second set of qualified physical devices that can each host the second set of logical devices, and deploying the application on only one member of the second set of qualified physical devices.

5. The method of claim 4 further comprising:
traversing the data tree to produce the minimum partition necessary to deploy application instances on the qualified physical devices.

6. The method of claim 5 further comprising:
connecting the application instance on the qualified physical device to its peer logical devices.

7. The method of claim 3 further comprising:
deploying, when a deployment attribute for removal of dependencies is present, an application instance with a partition where specified absolute and relative paths of the data tree have been trimmed off.

8. The method of claim 7 further comprising:
traversing the data tree to produce the minimum partition necessary to deploy application instances on the qualified physical devices while ignoring the explicitly specified paths.

9. The method of claim 8 further comprising:
connecting the application instance on the qualified physical device to its peer logical devices.

10. The method of claim 1 further comprising:
using a portion of the data tree as a minimum partition.

11. The method of claim 1 further comprising:
using the entire data tree as a minimum partition.

12. The method of claim 11 further comprising:
using the entire data tree as a minimum partition if the meta data does not contain a partitioning attribute.

13. A method for automatically deploying and running any number of independent instances of an application within an IoT network, comprising:
receiving, performed at least in part with a configuration of computing hardware and programmable memory, an application created by a developer;
receiving, performed at least in part with a configuration of computing hardware and programmable memory, the application meta data, as created by a developer, for the automatic deployment of the application;
receiving, performed at least in part with a configuration of computing hardware and programmable memory, the application including, in the meta data, a deployment policy;
using, performed at least in part with a configuration of computing hardware and programmable memory, the meta data to automatically generate a GUI by which an end-user builds a data tree configured for a specific IoT network;
presenting, to an IoT controller, performed at least in part with a configuration of computing hardware and programmable memory, the application and the data tree;
traversing the data tree, performed at least in part with a configuration of computing hardware and programmable memory, find the minimum partition for each qualified physical device;
using the found minimum partitions, the IoT controller does steps, performed at least in part with a configuration of computing hardware and programmable memory, comprising the following for each qualified physical device:
loading, performed at least in part with a configuration of computing hardware and programmable memory, an instance of the application;
giving, performed at least in part with a configuration of computing hardware and programmable memory, the application instance that minimum partition containing the peer logical devices to which it needs to connect; and
connecting, performed at least in part with a configuration of computing hardware and programmable memory, the application instance to its peer logical devices.

14. A system for an internet-of-things controller, for automatically deploying and running any number of independent instances of an application within an IoT network, comprising:
a sub-system configured, at least in part with computing hardware and programmable memory, to accomplish receiving an application created by a developer;
a sub-system configured, at least in part with computing hardware and programmable memory, to accomplish receiving the application meta data, as created by a developer, for the automatic deployment of the application;
a sub-system configured, at least in part with computing hardware and programmable memory, to accomplish receiving the application including, in the meta data, a deployment policy;
a sub-system configured, at least in part with computing hardware and programmable memory, to accomplish using the meta data to automatically generate a GUI by which an end-user builds a data tree configured for a specific IoT network;
a sub-system configured, at least in part with computing hardware and programmable memory, to accomplish presenting, to an IoT controller, the application and the data tree;
a sub-system configured, at least in part with computing hardware and programmable memory, to accomplish the following: traversing the data tree, find the minimum partition for each qualified physical device;
a sub-system configured, at least in part with computing hardware and programmable memory, to accomplish the following: using the found minimum partitions, the IoT controller does steps comprising the following for each qualified physical device:
loading an instance of the application;
giving the application instance that minimum partition containing the peer logical devices to which it needs to connect; and
connecting the application instance to its peer logical devices.
